(19) United States
(12) Patent Application Publication
(10) Pub. No.: US 2026/0307075 A1
(43) Pub. Date: Oct. 8, 2026

(54) SPECIMEN COLLECTOR WITH DUAL COLLECTION MATRICES AND METHOD OF USE

(71) Applicant: Bode Cellmark Forensics, Inc., Lorton, VA (US)

(72) Inventors: Daniel Watsula, Lorton, VA (US); Manzar Ahmed, Lorton, VA (US)

(21) Appl. No.: 19/638,288

(22) Filed: Apr. 3, 2026

Related U.S. Application Data
(60) Provisional application No. 63/783,063, filed on Apr. 3, 2025.

(51) Int. Cl. B01L 3/00; G01N 1/02

(52) U.S. Cl. CPC B01L 3/5029; G01N 1/02; B01L 2200/141; B01L 2200/185; G01N 2001/028

(57) ABSTRACT

The present invention relates to a specimen collector apparatus with dual collection matrices and methods of use. The present invention also relates to a specimen collector apparatus with dual collection matrices for specimen collection, drying, and transport, and methods of use. Dual swabs with dual collection matrices are arranged side by side and may be applied to a crime scene specimen to collect two samples of the specimen. The dual swab collection matrices are chosen based on test method compatibility needs so that each collected sample may be analyzed by a different testing method.

All patents, patent applications and publications cited herein are hereby incorporated by reference in their entirety. The disclosures of these publications in their entireties are hereby incorporated by reference into this application to more fully describe the state of the art as known to those skilled therein as of the date of the invention described and claimed herein.

This patent disclosure contains material that is subject to copyright protection. The copyright owner has no objection to the facsimile reproduction by anyone of the patent document or the patent disclosure as it appears in the U.S. Patent and Trademark Office patent file or records, but otherwise reserves any and all copyright rights.

### FIELD OF THE INVENTION

The present invention relates to a specimen collector apparatus with dual collection matrices and methods of use. The present invention also relates to a specimen collector apparatus with dual collection matrices for specimen collection, drying, and transport, and methods of use.

### BACKGROUND OF THE INVENTION

Crime scene evidence is collected to establish facts related to a crime or a suspected crime, for suspect identification, and for elimination of persons from further investigation. Such evidence may include samples of specimens collected from the crime scene or from persons related to the crime. The collected samples may be analyzed to produce results for presentation at a trial to establish guilt or innocence of accused individuals.

Samples collected from crimes scene specimens may include unknown substances, chemicals, fluids, and biological substances, the composition of which may be determined or confirmed by forensic testing. Samples may also include biological substances from which a person's identity may be determined or confirmed. The specimens to be sampled may be very small in quantity, may be dispersed over a comparatively large area, and may include materials such as: body fluids, hairs, flakes of skin such as skin cells, fibers, drugs, various chemicals, gunpowder residue, flammable materials, tobacco ashes, cosmetics, and the like.

Samples collected from crimes scenes may be subjected to forensic testing by methods including forensic analysis, chemical analysis, bioanalytical analysis, and/or DNA analysis for identification or for association with a particular individual. DNA analysis may be performed in the field or in a laboratory. Field testing may be performed by a rapid DNA test. Laboratory testing may also be performed by a rapid DNA test or by a more conventional standard DNA test.

Conventional sample collectors include swabs, which contain a shaft of wood, tubular plastic, or paper. An absorbent material or “collection matrix” attached to the end of the shaft forms the swab, which is contacted with a crime scene specimen to collect a sample. Swab collection matrices may be fibrous, flocked, spun, foam, knitted, or mesh in design and may contain any of several swab materials. Swab materials include cotton, cellulose, or other polymeric materials, such as polyester, nylon, and the like.

Fibrous cotton swabs are often used for collecting DNA evidence. Such swabs not only absorb liquids and solids suspended in liquids but also trap dry substances such as particulate materials. Samples collected onto fibrous swabs are slowly released from the collection matrix and are typically analyzed by standard DNA tests.

Flocked swabs made from polymeric materials may also be used for collecting DNA evidence. Samples collected onto flocked swabs are released more rapidly from the flocked fibers compared to cotton fibers. This rapid release rate allows the sample to be analyzed by modern rapid DNA testing methods.

A problem with current specimen collector design is they contain a single swab collection matrix and are, therefore, compatible with limited method of testing. The present invention addresses these limitations by providing a specimen collector device with dual swab collection matrices and methods of use. The dual swabs are arranged side by side and may be applied to the same crime scene specimen to collect two samples for analysis by at least two different testing methods.

### SUMMARY OF THE INVENTION

The present invention provides a specimen collector apparatus with dual collection matrices and methods of use. The present invention also provides a specimen collector apparatus with dual collection matrices for specimen collection, drying, and transport, and methods of use.

In one aspect, the present invention provides a specimen collection device 1 comprising a specimen collector assembly 2 comprising at least two specimen collectors 3 extending from a central member 4, the specimen collectors 3 comprising: (a) a first swab 5a comprising a first collection matrix 6a connected to a first shaft 7a, the shaft having a first shaft end with the first collection matrix 6a thereon and a second shaft end connected to the central member 4; (b) a second swab 5b comprising a second collection matrix 6b connected to a second shaft 7b, the shaft having a first shaft end with the second collection matrix 6b thereon and a second shaft end connected to the central member 4; wherein the first and second swabs 5a and 5b are configured to simultaneously contact one or more specimens to collect one or more samples on the swabs, the first swab 5a being positioned to not contact the second swab 5b.

In certain embodiments of the device 1: (a) the first collection matrix 6a and the second collection matrix 6b are each independently selected from Group (I), consisting of a flocked matrix, a fibrous matrix, a foam matrix, a spun matrix, a knitted matrix, a mesh matrix, a cotton matrix, a cellulose matrix, a calcium alginate matrix, a microfiber matrix, a polymeric matrix, a polyester matrix, a nylon matrix, a rayon matrix, a polyethylene matrix, a polyethylene terephthalate matrix, a matrix comprising dissolvable polymers, a matrix comprising bicomponent fibers, a polypropylene matrix, a polyurethane matrix, a polyacrylonitrile matrix, and a polylactic acid matrix; and (b) the matrix of the first collection matrix 6a and the second collection matrix 6b are different.

In certain embodiments of the device 1: (a) the first collection matrix 6a comprises said flocked matrix; and the second collection matrix 6b comprises a non-flocked matrix selected from said Group (I); (b) the first collection matrix 6a comprises said flocked matrix; and the second collection matrix 6b comprises said fibrous matrix, said foam matrix, said spun matrix, said knitted matrix, or said mesh matrix; (c) the first collection matrix 6a comprises said flocked matrix comprising one or more fibers selected from the group consisting of microfibers, polymeric fibers, polyester fibers, nylon fibers, rayon fibers, polyethylene fibers, polyethylene terephthalate fibers, dissolvable polymeric fibers, bicomponent fibers, polypropylene fibers, polyurethane fibers, polyacrylonitrile fibers, and polylactic acid fibers; and the second collection matrix 6b comprises said fibrous matrix, said foam matrix, said spun matrix, said knitted matrix, or said mesh matrix comprising one or more fibers selected from the group consisting of cotton fibers, cellulose fibers, calcium alginate fibers, microfibers, polymeric fibers, polyester fibers, nylon fibers, rayon fibers, polyethylene fibers, polyethylene terephthalate fibers, dissolvable polymeric fibers, bicomponent fibers, polypropylene fibers, polyurethane fibers, polyacrylonitrile fibers, and polylactic acid fibers; (d) the first collection matrix 6a comprises said flocked matrix comprising polyester fibers and/or nylon fibers; and the second collection matrix 6b comprises said fibrous matrix, said spun matrix, said knitted matrix, or said mesh matrix comprising cotton fibers; or (e) the first collection matrix 6a comprises said flocked matrix comprising polyester fibers and/or nylon fibers; and the second collection matrix 6b comprises said spun matrix comprising cotton fibers.

In certain embodiments of the device 1: (a) the first collection matrix 6a and the second collection matrix 6b are compatible with a laboratory DNA test, a laboratory chemical test, any laboratory test, a rapid DNA test, a rapid chemical test, and/or any rapid field test; (b) the first collection matrix 6a is compatible with at least said rapid DNA test, said rapid chemical test, or any rapid field test; and the second collection matrix 6b is compatible with at least said laboratory DNA test, said laboratory chemical test, or any laboratory test; or (c) the first collection matrix 6a is compatible with at least said rapid DNA test, said rapid chemical test, or any rapid field test that uses smaller amounts of liquid than previous iterations of said rapid test; and the second collection matrix 6b is compatible with at least said laboratory DNA test, said laboratory chemical test, or any laboratory test.

In certain embodiments of the device 1, said one or more samples on the swabs comprise (i) two samples of the same specimen, (ii) a sample of the specimen and a sample of an adjacent specimen, (iii) a sample of the specimen and a control sample, or (iv) two control samples.

In certain embodiments of the device 1, said central member 4 forms part of a container closure 9 having a first side 9a and a second side 9b, which are opposed sides of said central member 4, and wherein: (a) the specimen collectors 3 extend from the first side 9a of the container closure 9; and (b) the second shaft ends of the first and second swabs 5a, b are connected to the first side 9a of the container closure 9.

In certain embodiments of the device 1, said container closure 9 further comprises: (a) a first stopper structure 10a extending from the first side 9a of the central member 4; (b) a second stopper structure 10b or a handle for the specimen collector assembly 2 extending from the second side 9b of the central member 4; (c) a first void hole 11a and a second void hole 11b located on the first side 9a of the container closure 9 into which the second shaft ends of the first and second swabs 5a, b are positioned; and (d) optionally at least one air hole 12 communicating through the stopper structures 10a, b and the central member 4 of the container closure 9.

In certain embodiments of the device 1, the specimen collector assembly 2 further comprises a first generally rigid tube 8a mounted coaxially on the first shaft 7a and a second generally rigid tube 8b mounted coaxially on the second shaft 7b, each generally rigid tube 8a, b having: (a) a first end of each generally rigid tube 8a, b connected to the first side 9a of the container closure 9, the first end of each generally rigid tube 8a, b being optionally positioned inside the first and second void holes 11a, b of the container closure 9; and (b) a second end optionally terminating at a shaft break point, which is optionally perforated, on each of said shafts 7a, b, said optional shaft break points being positioned along each of said shafts 7a, b at a location sufficiently spaced from each of said swabs 5a, b to permit the entire swab to be separated from the shaft when the shaft is broken at said shaft break point.

In certain embodiments, the device 1 further comprises a housing container 13 for holding and/or transporting the specimen collector assembly 2, the housing container 13 comprising an opening 16, wherein the first side 9a of said container closure 9 is insertable into the opening 16, wherein the housing container 13: (a) comprises any container of sufficient size and shape to permit insertion of the specimen collectors 3 without contacting the specimen collectors 3, the first and second swabs 5a, b, or the first and second collection matrices 6a, b; and (b) is configured to isolate and contain at least the first and second swabs 5a, b without contacting the first and second swabs 5a, b or the first and second collection matrices 6a, b.

In certain embodiments of the device 1, the housing container 13: (a) is configured to act both as a handle for the specimen collector assembly 2 during specimen collection and to act as a transport container during specimen shipping; (b) comprises a desiccant chamber 14; (c) comprises a neck 15 extending from the desiccant chamber 14, the neck 15 having said opening 16 providing communication through the neck 15 and into the desiccant chamber 14, wherein said first stopper structure 10a and/or said second stopper structure 10b are insertable into the opening 16 of the neck 15, which is tapered to form a seat 17 for one or both stopper structures 10a, b; (d) comprises a swab isolation region 18 in the desiccant chamber 14 the swab isolation region 18 aligned with the neck 15 to permit insertion of the first and second swabs 5a, b through the opening 16, through the neck 15, and into the swab isolation region 18; (e) comprises a desiccant holding region 19 on at least one sidewall of the desiccant chamber 14, the desiccant holding region 19 configured to retain at least one desiccant packet 20 therein to absorb moisture from a specimen collected on the first and second swabs 5a, b; (f) comprises a base cap 21 on the desiccant chamber 14, wherein the base cap 21 is optionally openable and closeable and is optionally configured to permit removal of the desiccant packet 20 from the desiccant holding region 19 and insertion of the desiccant packet 20 into the desiccant holding region 19 while the first and second swabs 5a, b are in the swab isolation region 18 of the desiccant chamber 14; or (g) any combination of (a)-(f).

In certain embodiments, the device 1 further comprises one or more retaining structures 22 in the desiccant chamber 14 the retaining structures 22 being configured to hold the desiccant packet 20 in the desiccant holding region 19 and away from contact with the first and second swabs 5a, b, wherein the retaining structures 22: (a) comprise rigid flanges extending from opposed sidewalls of the desiccant chamber 14; (b) comprise flexible retainers extending downwardly from a top wall of the desiccant chamber 14; (c) comprise flexible projections extending upwardly from the optionally openable and closeable base cap 21; or (d) comprise flexible projections extending both downwardly from the top wall and inwardly from opposed sidewalls of the desiccant chamber 14.

In certain embodiments of the device 1: (a) the two specimen collectors 3 have approximately the same total lengths (extending from the central member 4), thereby allowing the two specimen collectors 3 to simultaneously contact a specimen surface; (b) optionally, the two specimen collectors 3 have approximately the same stiffnesses, wherein the combination of (a) and (b) allows the two specimen collectors 3 to simultaneously contact a specimen surface with approximately the same contact force between each specimen collector and the specimen; (c) a total length of the first shaft 7a and the first swab 5a extending from the central member 4 is approximately the same as a total length of the second shaft 7b and the second swab 5b extending from the central member 4, thereby allowing the first and second swabs 5a and 5b to simultaneously contact a specimen surface; (d) a stiffness of the first swab 5a comprising the first collection matrix 6a connected to the first shaft 7a is approximately the same as a stiffness of the second swab 5b comprising the second collection matrix 6b connected to the second shaft 7b; (e) a stiffness of the first shaft 7a is approximately the same as a stiffness of the second shaft 7b; (f) a combined stiffness of the first shaft 7a and the first swab 5a is approximately the same as a combined stiffness of the second shaft 7b and the second swab 5b; (g) a diameter of the first shaft 7a is approximately the same as a diameter of the second shaft 7b; (h) each generally rigid tube 8a and 8b has approximately the same length; (i) each generally rigid tube 8a and 8b has approximately the same stiffness; (j) each generally rigid tube 8a and 8b has a stiffness that is greater than the stiffness of the first shaft 7a and the second shaft 7b; or (k) any combination of (a)-(j), wherein certain combinations of (a)-(j) allow the first and second collection matrices 6a and 6b of the first and second swabs 5a and 5b to be simultaneously pressed against a flat specimen surface while applying approximately the same contact force between each swab and the surface.

In another aspect, the present invention provides a method of specimen collection comprising the steps of: (a) applying one or both swabs of a specimen collection device 1 comprising a specimen collector assembly 2 comprising at least two specimen collectors 3 according to any of the foregoing aspects or embodiments, to at least one specimen, wherein the two specimen collectors 3 comprise a first swab 5a comprising a first collection matrix 6a connected to a first shaft 7a, the shaft having a first shaft end with the first collection matrix 6a thereon and a second shaft end connected to the central member 4; and a second swab 5b comprising a second collection matrix 6b connected to a second shaft 7b, the shaft having a first shaft end with the second collection matrix 6b thereon and a second shaft end connected to the central member 4, wherein the first and second swabs 5a and 5b are configured to simultaneously contact one or more specimens to collect one or more samples of the one or more specimens on the swabs, the first swab 5a being positioned to not contact the second swab 5b; and (b) collecting a sample of the at least one specimen onto one or both swabs, thereby providing a first sample on the first collection matrix 6a and/or a second sample on the second collection matrix 6b.

In certain embodiments of the method the first swab and the second swab are simultaneously or subsequently applied to: (a) two adjacent areas on the same specimen; (b) a same area on the same specimen; (c) areas on two adjacent specimens; (d) a specimen and an adjacent control area; (e) two adjacent control areas.

In certain embodiments of the method said one or more samples on the swabs comprise (i) two samples of the same specimen, (ii) a sample of the specimen and a sample of an adjacent specimen, (iii) a sample of the specimen and a control sample, or (iv) two control samples.

In certain embodiments the method further comprises the steps of: (a) analyzing the first sample on the first collection matrix 6a for data regarding the specimen or the control; and/or (b) analyzing the second sample on the second collection matrix 6b for data regarding the specimen or the control.

In certain embodiments the method further comprises the steps of: (a) analyzing the first sample on the first collection matrix 6a and/or the second sample on the second collection matrix 6b using a laboratory DNA test, a laboratory chemical test, any laboratory test, a rapid DNA test, a rapid chemical test, and/or a rapid field test for data regarding the specimen or the control, optionally wherein the rapid DNA test, the rapid DNA test, and/or the rapid field test uses smaller amounts of liquid than previous iterations of said rapid test; (b) analyzing the first sample on the first collection matrix 6a using said rapid DNA test, said rapid chemical test, or said rapid field test for data regarding the specimen or the control, wherein the rapid DNA test, the rapid DNA test, and/or the rapid field test uses smaller amounts of liquid than previous iterations of said rapid test; (c) analyzing the second sample on the second collection matrix 6b using a laboratory DNA test, a laboratory chemical test, or a laboratory test for data regarding the specimen to provide specimen data; or (d) a combination of (b) and (c).

In certain embodiments the method further comprises the steps of: (a) pre-wetting the one or more specimens with sterile water, water, a liquid, or a solution optionally comprising one or more surfactants prior to applying the swabs to the specimen; (b) pre-wetting one or both of said first and second swabs 5a and 5b and/or one or both of said first and second collection matrices 6a and 6b with sterile water, water, a liquid, or a solution optionally comprising one or more surfactants prior to applying the swabs to the specimen; (c) after collecting the sample of the specimen, inserting both swabs 5a and 5b into the neck 15 of the housing container 13 to place the swabs in the swab isolation region 18 of the desiccant chamber 14; (d) after inserting both swabs 5a, b into the opening 16 of the neck 15 of the housing container 13, aligning the first swab 5a or second swab 5b with an indicator located on the neck 15 of the housing container 13, wherein both swabs are positioned within the swab isolation region 18 in a position that provides uniform separation between each of the swabs and the desiccant packets 20; (e) inserting one or more desiccant packets 20 into the desiccant holding region 19, wherein the one or more desiccant packets 20 are held in place and away from contact with the first and second swabs 5a, b by said retaining structures 22; (f) drying both swabs within the desiccant chamber 14; (g) during the step of drying both swabs, optionally replacing one or more of said desiccant packets 20 in the desiccant holding region 19; (h) transporting the swabs to a second location; or (i) any combination of (a)-(h).

In certain embodiments of the method: (a) the first and second collection matrices 6a and 6b are applied to the specimen surface, optionally applied simultaneously to the same specimen surface, with approximately the same contact force between each collection matrix and the specimen surface; (b) the first and second swabs 5a and 5b are applied to the specimen surface, optionally applied simultaneously to the same specimen surface, with approximately the same contact force between each swab and the specimen surface; (c) a total length of the first shaft 7a and the first swab 5a extending from the central member 4 is approximately the same as a total length of the second shaft 7b and the second swab 5b extending from the central member 4; (d) a stiffness of the first swab 5a comprising the first collection matrix 6a connected to the first shaft 7a is approximately the same as a stiffness of the second swab 5b comprising the second collection matrix 6b connected to the second shaft 7b; (e) a stiffness of the first shaft 7a is approximately the same as a stiffness of the second shaft 7b; (f) a combined stiffness of the first shaft 7a and the first swab 5a is approximately the same as a combined stiffness of the second shaft 7b and the second swab 5b; (g) a diameter of the first shaft 7a is approximately the same as a diameter of the second shaft 7b; (h) the two specimen collectors 3 have approximately the same total lengths; (i) the two specimen collectors 3 have approximately the same stiffnesses; or (j) any combination of (a)-(i), wherein the combination of (a) and (b) allows the two specimen collectors 3 to simultaneously contact a specimen surface with approximately the same contact force between each specimen collector and the specimen; and further wherein certain combinations of (a)-(i) allow the first and second collection matrices 6a and 6b of the first and second swabs 5a and 5b to be simultaneously pressed against a flat specimen surface while applying approximately the same contact force between each swab and the surface.

### BRIEF DESCRIPTION OF THE DRAWINGS

The invention will be described in more detail with reference to appended drawings, described in detail below. The drawings, including all measurements disclosed therein, such as dimensional measurements including lengths, widths, inner diameters (I.D.), and outer diameters (O.D.) are exemplary and are not intended to be limiting in any way.

FIG. 1 shows an exemplary embodiment of a specimen collector device 1 with housing container 13 and specimen collector assembly 2 having dual specimen collectors 3 terminating in dual collection matrices 6a and 6b for collecting samples of a specimen according to Example 1.

FIG. 2 shows an exemplary embodiment of container closure 9 and dual void holes 11a and 11b therein which permit the positioning and securing of dual specimen collectors 3 within the closure as shown in FIG. 1.

FIGS. 3A-B show exemplary cross-sectional views of an embodiment of dual specimen collectors 3. FIG. 3A shows dual specimen collectors 3 having dual shafts 7a and 7b, with shaft 7a terminating in a flocked polyester first swab 5a with a flocked polyester first collection matrix 6a thereon and shaft 7b terminating in a fibrous cotton second swab 5b with a fibrous cotton second collection matrix 6b thereon and for collecting samples of a specimen according to Examples 1-2. FIG. 3B shows an expanded view of the dual specimen collectors 3.

FIGS. 4A-B show exemplary cross-sectional views of another embodiment of dual specimen collectors 3. FIG. 4A shows dual specimen collectors 3 having dual shafts 7a and 7b, with shaft 7a terminating in a flocked polyester first swab 5a with a flocked polyester first collection matrix 6a thereon and shaft 7b terminating in a fibrous cotton second swab 5b with a fibrous cotton second collection matrix 6b thereon. FIG. 4B shows an exemplary expanded view of the dual specimen collectors 3.

FIG. 5 shows exemplary run result status indicators for Rapid DNA testing according to Example 1.

FIGS. 6A-C show exemplary pictures of devices used for collecting samples of a specimen. FIG. 6A shows exemplary pictures of an embodiment of the inventive dual collection matrix test device (RapidSwab) in open configuration (top) and closed configuration (bottom) for collecting samples of a specimen according to Examples 1-2. FIG. 6B shows exemplary pictures of another embodiment of the inventive dual collection matrix test device (RapidSwab) with alternate label placement. FIG. 6C shows an exemplary picture of Puritan swabs for collecting samples of a specimen according to Example 2.

FIG. 7 shows exemplary pictures of transport packaging containing blood samples transferred from Puritan swabs according to Example 2.

FIGS. 8A-B shows exemplary graphs of results for samples collected from blood stained glass surfaces according to Example 2. FIG. 8A shows results for DNA Quantity (ng/μL) and DNA Degradation Index (DI). FIG. 8B shows results for Total DNA (ng).

FIGS. 9A-B shows exemplary graphs of results for samples collected from blood stained cotton fabric surfaces according to Example 2. FIG. 9A shows results for DNA Quantity (ng/μL) and DNA Degradation Index (DI). FIG. 9B shows results for Total DNA (ng).

FIGS. 10A-B shows exemplary graphs of results for samples collected from saliva stained glass surfaces according to Example 2. FIG. 10A shows results for DNA Quantity (ng/μL) and DNA Degradation Index (DI). FIG. 10B shows results for Total DNA (ng).

FIGS. 11A-B shows exemplary graphs of results for samples collected from saliva stained cotton fabric surfaces according to Example 2. FIG. 11A shows results for DNA Quantity (ng/μL) and DNA Degradation Index (DI). FIG. 11B shows results for Total DNA (ng).

### DETAILED DESCRIPTION OF THE INVENTION

Before describing the invention, the following definitions are provided. Unless stated otherwise all terms are to be construed as they would be by a person skilled in the art.

### Definitions

All technical and scientific terms used herein have the same meaning as commonly understood to one of ordinary skill in the art to which this invention belongs unless clearly indicated otherwise.

As used herein the singular forms “a”, “an”, and “the” include plural referents unless the context clearly dictates otherwise. The singular forms “a,” “an,” and “the” may mean “one” but also include plural referents such as “one or more” and “at least one” unless the context clearly dictates otherwise.

As used herein, the term “about” means plus or minus 10%, plus or minus 5%, plus or minus 1% or plus or minus 0.1% of the numerical value of the number with which it is being used.

As used herein, “approximately the same” means sufficiently similar such that any differences between the compared values, dimensions, properties, or characteristics do not materially affect the intended function, operation, or result of the described element or system, as understood by a person of ordinary skill in the art in view of this disclosure. In certain embodiments, “approximately the same” may mean that compared characteristics, such as lengths, diameters, or stiffnesses, are experienced by a user as being functionally equivalent based on user perception. In certain non-limiting embodiments, “approximately the same” may refer to compared characteristics, such as lengths, diameters, or stiffnesses, with variations up to plus or minus 30%, plus or minus 20%, plus or minus 10%, plus or minus 5%, plus or minus 1%, or plus or minus 0.1%.

As used herein, the term “or” in the claims is used to mean “and/or” unless explicitly indicated to refer to alternatives only or the alternatives are mutually exclusive, although the disclosure supports a definition that refers to only alternatives and “and/or.”

As used herein the term “or combinations thereof” as used herein refers to all permutations and combinations of the listed items preceding the term unless stated otherwise.

As used herein, the term “aqueous solution” or “solution” refers to a mixture of water and a water-soluble solute or solutes.

As used herein, the terms “matrix”, “collection matrix”, “swab matrix”, and “swab collection matrix” are used interchangeably to refer to the collection matrix material itself, which is mounted at the end of a shaft to form a swab.

As used herein, the term “flocked swab” generally refers to a swab prepared with short fibers arranged perpendicularly around a shaft end. “Flocking” is the process in which short fibers or fiber particles are deposited onto the tip of a shaft end to create a flocked layer around the tip of the swab. The flocked fibers create thousands of contact points for collecting samples. Flocked swabs collect samples between the flocked fibers, from which the samples can be more rapidly eluted.

As used herein, the term “fibrous swab” refers to generally refers a shaft with fibers wrapped around the tip. Fibrous swabs may be prepared by wrapping or winding a long fiber or collection of fibers around a shaft end. The wound fibers may be bound to the shaft with a binder, such as methylcellulose. Traditional fiber swabs, such as cotton swabs, absorb samples inside a wad of fiber, where the sample stays entrapped for longer periods of time.

As used herein, the terms “polymeric” and similar terms are used in their ordinary sense as understood by one skilled in the art and thus, may be used herein to refer to or describe being formed from fibers of a large molecule (or group of such molecules) that may comprise recurring units. Polymers may be formed in various ways, including by polymerizing monomers and/or by chemically modifying one or more recurring units of a precursor polymer. Unless otherwise specified, a polymer may comprise a “homopolymer” that may comprise substantially identical recurring units that may be formed by, for example, polymerizing a particular monomer. Unless otherwise specified, a polymer may also comprise a “copolymer” that may comprise two or more different recurring units that may be formed by, for example, copolymerizing, two or more different monomers, and/or by chemically modifying one or more recurring units of a precursor polymer. Unless otherwise specified, a polymer or copolymer may also comprise a “terpolymer” or a “tetrapolymer” which generally refer to polymers that comprise three, four, or more different recurring monomer units. The term “polymer” as used herein is intended to include both the acid form of the polymer as well as its various salts. Polymers may be amphoteric in nature, that is, containing both anionic and cationic substituents, although not necessarily in the same proportions.

As used herein, the term “RFU” refers to relative fluorescence units.

As used herein, the terms “sample” and “collected sample” are used interchangeably to refer to a portion or singe unit of material that has been collected from a specimen. For example, a sample of a specimen may be collected onto the collection matrix of a swab. The sample may be trapped, wicked, adsorbed, intercalated into, or absorbed into the matrix of the swab. The sample may also be coated onto the swab.

As used herein, the term “sample release rate” refers to the amount of sample material released from a swab over a period of time.

As used herein, the term “specimen” refers to any material of interest to be sampled. Specimens to be sampled may include unknown substances, chemicals, fluids, and biological substances, the composition of which may be determined or confirmed by forensic testing. Specimens to be sampled may also include biological substances from which a person's identity may be determined or confirmed. Specimens to be sampled may be very small in quantity, may be dispersed over a comparatively large area, and may include materials such as: body fluids, hairs, flakes of skin such as skin cells, fibers, drugs, various chemicals, gunpowder residue, flammable materials, tobacco ashes, cosmetics, and the like.

As used herein, the term “specimen collector”, “evidence collector”, and “sample collector” are used interchangeable to refer to a device for collecting one or more samples of a specimen.

As used herein, the term “swab” refers to a shaft end and collection matrix thereon. As used herein, the term “dual swab” refers to two swabs side-by-side. As used herein, the term “dual swab matrices” refers to two swabs side-by-side, each swab having a different collection matrix.

### DESCRIPTION OF THE INVENTION

Detailed embodiments of the present inventions are disclosed herein; however, it is to be understood that the disclosed embodiments are merely exemplary of the invention, which may be embodied in various forms. Therefore, specific structural and functional details and specific method details disclosed herein are not to be interpreted as limiting, but merely as a basis for the claims and as a representative basis for teaching one skilled in the art to variously employ the present invention in virtually any appropriately detailed structure.

Evidence collectors have been disclosed that contain two identical swabs connected to the same sample collection device (U.S. Pat. Nos. 8,696,595, 8,940,547, and 9,052,254, which are hereby incorporated by reference in their entirety).

Current specimen collector designs are limited in that they contain only a single swab collection matrix, such as a cotton swab matrix, and are therefore compatible with only a limited group of standard testing methods. For example, cotton swabs are generally compatible with standard laboratory DNA testing methods and are not generally compatible with modern rapid DNA field testing methods.

The present invention provides a specimen collector device with dual swab collection matrices and methods of use. The dual swabs are arranged side by side and may be applied to the same crime scene specimen to collect two samples of a specimen. The dual swab collection matrices may be chosen based on test method compatibility needs so that each collected sample may be analyzed by a different testing method, as needed. For example, the dual swab collection matrices may include a fibrous cotton swab matrix and a flocked swab matrix, which are compatible with standard laboratory DNA testing methods and modern rapid DNA field testing methods, respectively.

### Specimen Collector Device

Referring now to the drawing figures, the reference numeral 1 generally designates a specimen collector device 1, which generally includes a specimen collector assembly 2 with dual specimen collectors 3 terminating in a first and second swab 5a and 5b, which generally include a first collection matrix 6a and a second collection matrix 6b. The device 1 may include the specimen collector assembly 2 alone, or may also include a housing container, such as housing container 13, into which the dual specimen collectors 3 are insertable for drying, storage, and/or transport. It will be appreciated that the utilized device 1 may also include any alternate housing container, storage container, drying container, or transport container known in the art into which the dual specimen collectors 3 are insertable for drying, storage, and/or transport.

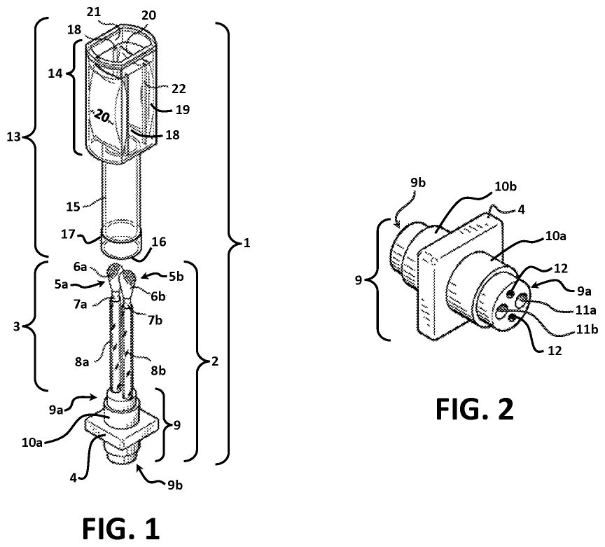

Referring to FIGS. 1-4, it will be appreciated that the specimen collector device 1, when utilized for specimen collection, generally includes at least the specimen collector assembly 2 with dual collection matrices 6a and 6b as illustrated in FIG. 1. The specimen collector assembly 2 may be used by methods disclosed herein to collect two samples of a specimen, thereby providing a first collected sample on the first collection matrix 6a and a second collected sample on the second collection matrix 6b.

FIG. 1 shows an embodiment of the specimen collector device 1. The illustrated specimen collector device 1 may be utilized as the specimen collector assembly 2 only, without a housing container. The specimen collector device 1 may also be utilized as the specimen collector assembly 2 along with housing container 13, into which the dual specimen collectors 3 are insertable for drying, storage, and/or transport, as illustrated in FIG. 1. It will also be appreciated that the specimen collector device 1 may be utilized as the specimen collector assembly 2 along with any housing container, storage, container, drying container, or transport container known in the art into which the dual specimen collectors 3 are insertable for drying, storage, and/or transport.

According to FIG. 1, the illustrated specimen collector device 1 assembly includes the specimen collector assembly 2, including dual specimen collectors 3 extending from a central member 4. The dual specimen collectors 3 include a first shaft 7a terminating in a first swab 5a with a first collection matrix 6a, the shaft having a first shaft end with the first collection matrix 6a thereon and a second shaft end connected to the central member 4. The dual specimen collectors 3 also include a second shaft 7b terminating in a second swab 5b with a second collection matrix 6b, the shaft having a first shaft end with the second collection matrix 6b thereon and a second shaft end connected to the central member 4. The first and second swabs 5a and 5b are configured to simultaneously contact one or more specimens to collect one or more samples on the swabs, the first swab 5a being positioned to not contact the second swab 5b.

Each specimen collector 3 extending from central member 4 may have approximately the same total length or may have different lengths, according to end user requirements.

The total length of the first swab 5a comprising the first collection matrix 6a and the first shaft 7a may be approximately the same or different compared to the total length of the second swab 5b comprising the second collection matrix 6b and the second shaft 7b.

The total length of the first shaft 7a and the first swab 5a extending from the central member 4 may be approximately the same or different compared to the total length of the second shaft 7b and the second swab 5b extending from the central member 4.

In certain embodiments, each specimen collector 3 extending from central member 4 may have approximately the same total length or the specimen collectors 3 may have different total lengths. In certain embodiments, a total length of the first shaft 7a and the first swab 5a extending from the central member 4 may be approximately the same as a total length of the second shaft 7b and the second swab 5b extending from the central member 4. In this manner, the first and second collection matrices 6a and 6b of the first and second swabs 5a and 5b may be configured to simultaneously contact one or more specimens to collect one or more samples of the one or more specimens on the swabs.

The diameter and/or the stiffness of the first shaft 7a may be approximately the same or different compared to the diameter and/or the stiffness of the second shaft 7b. The first shaft 7a the second shaft 7b may be manufactured from the same materials for from different materials. In certain embodiments, the stiffness of the first shaft 7a may be approximately the same as the stiffness of the second shaft 7b.

In certain embodiments, (i) each specimen collector 3 extending from central member 4 has approximately the same total length, (ii) the total length of the first shaft 7a and the first swab 5a extending from the central member 4 is approximately the same as a total length of the second shaft 7b and the second swab 5b extending from the central member 4; and (iii) the stiffness of the first shaft 7a may be approximately the same as the stiffness of the second shaft 7b. In this manner, the first and second swabs 5a and 5b are configured to be simultaneously pressed against a flat specimen surface while applying approximately the same contact force between each swab and the surface.

According to FIG. 1, the illustrated specimen collector device 1 comprises the central member 4, which forms part of a container closure 9 having a first side 9a and a second side 9b, which are opposed sides of said central member 4. The specimen collectors 3 extend from the first side 9a of the container closure 9 and the second shaft ends of the first and second swabs 5a and 5b are connected to the first side 9a of the container closure 9.

The first side 9a of the illustrated container closure 9 of FIG. 1 further includes a first stopper structure 10a and the second side 9b includes a second stopper structure 10b. It will be appreciated that the second side 9b may also include a handle structure, which may be any handle structure known in the art for manually manipulating the specimen collector assembly 2. The handle structure may be fixed or removable.

FIG. 2 shows an expanded view of the container closure 9 shown in FIG. 1. The illustrated container closure 9 of FIG. 2 may include at least one air hole 12 communicating through the stopper structures 10a and 10b and through the central member 4 of the container closure 9. The air holes allow for transfer of gasses and water vapor, such as by diffusion or by applying a vacuum. It will be appreciated that any number of air holes, such as 0, 1, 2, 3, or 4 air holes may be present in the container closure 9.

The illustrated container closure 9 of FIG. 2 further includes a first and second void holes 11a and 11b located on the first side 9a of the container closure 9 into which the second shaft ends of the first and second swabs 5a and 5b are positioned.

The illustrated specimen collector assembly 2 of FIG. 1 further includes a first generally rigid tube 8a mounted coaxially on the first shaft 7a and a second generally rigid tube 8b mounted coaxially on the second shaft 7b. Each illustrated generally rigid tube 8a, and 8b includes a first end of the generally rigid tube 8a, and 8b connected to the first side 9a of the container closure 9. The first end of each generally rigid tube 8a and 8b as illustrated may be optionally positioned inside the first and second void holes 11 a and 11b of the container closure 9, as shown in FIG. 2. Each illustrated generally rigid tube 8a and 8b also includes a second end optionally terminating at a shaft break point, which is optionally perforated, on each of said shafts 7a and 7b, said optional shaft break points being positioned along each of said shafts 7a, and 7b at a location sufficiently spaced from each of said swabs 5a, and 5b to permit the entire swab to be separated from the shaft when the shaft is broken at said shaft break point.

The stiffness of the first generally rigid tube 8a may be approximately the same or different compared to the stiffness of the second generally rigid tube 8b. In certain embodiments, the stiffness of each generally rigid tube 8a, and 8b may be approximately the same and further may be equal to or preferably greater than the stiffness of either or both of said shafts 7a and 7b, thereby allowing the first and second swabs 5a and 5b to be simultaneously pressed against a flat specimen surface while applying approximately the same contact force between each swab and the surface, even when shafts 7a and 7b have different stiffnesses.

For applications where the stiffness of each shaft 7a and 7b of the two specimen collectors is different, each of the shafts may be positioned within first and second generally rigid tubes 8a and 8b. The generally rigid tubes 8a and 8b may have approximately the same lengths and stiffnesses. The stiffness of each generally rigid tube may also be greater than the stiffness of each shaft 7a and 7b. In this manner, the first and second generally rigid tubes 8a and 8b allow the first and second swabs 5a and 5b of specimen collectors having shaft 7a and 7b of different stiffnesses to be simultaneously pressed against a flat specimen surface while applying approximately the same contact force between each swab and the surface.

It will be appreciated that the first and second void holes 11a and 11b of FIG. 2 are sufficiently spaced to allow for anchorage of the swabs with the first swab 5a being positioned to not contact the second swab 5b. It will also be appreciated that the first and second void holes 11a and 11b are sufficiently large in diameter to allow for secure anchorage of at least the first and second shafts 7a and 7b of the specimen collectors 3. It will also be appreciated that the first and second void holes 11a and 11b may be sufficiently large in diameter to allow for secure anchorage of the first and second shafts 7a and 7b along with the first ends of the first and second generally rigid tubes (i.e., break-off tubes) 8a and 8b mounted coaxially on the shafts. Each void hole may include a first diameter void hole, which allows for secure anchorage of generally rigid tubes 8a and 8b, and a second diameter void hole, located deeper within the void hole, the second diameter void hole being smaller than the first diameter void hole, which second diameter void hole allows for secure anchorage of the first and second shafts 7a and 7b, thereby allowing for simultaneous secure anchorage of both the shaft and the generally rigid tube in the same void hole.

The illustrated specimen collector device 1 of FIG. 1 further includes a housing container 13 for holding, storing, drying, and/or transporting the specimen collector assembly 2 without touching the specimen collectors 3. The housing container 13 includes an opening 16 that is sufficiently large to permit insertion of both specimen collectors 3 without touching the specimen collectors 3, the swabs 7a and 7b, or the collection matrices 6a and 6b.

It will be appreciated that the first stopper structure 10a of the first side 9a of said container closure 9 and both specimen collectors 3 are insertable into the opening 16, thereby allowing for secure anchorage of the specimen collector assembly 2 with the specimen collectors 3 positioned inside the illustrated housing container 13. It will also be appreciated that the that the second stopper structure 10b of the second side 9b of said container closure 9 is insertable into the opening 16, thereby allowing for secure anchorage of the specimen collector assembly 2 with the specimen collectors 3 positioned outside the housing container 13. In this manner, the illustrated housing container 13 may serve as a handle for the specimen collector assembly 2.

The illustrated housing container 13 also comprises a container of sufficient size and shape to permit insertion of the specimen collectors 3 without contacting the specimen collectors 3, the first and second swabs 5a and 5b, or the first and second collection matrices 6a and 6b.

The illustrated housing container 13 is also configured to isolate and contain at least the first and second swabs 5a and 5b without contacting the first and second swabs 5a and 5b and without contacting the first and second collection matrices 6a and 6b.

The illustrated housing container 13 is also long enough to accommodate insertion of the specimen collectors 3 until the stopper structure 10a firmly contacts the stopper seat 17 without the housing container 13 contacting any part of the specimen collectors 3 or the first and second swabs 5a and 5b.

The illustrated housing container 13 is configured to act both as a handle for the specimen collector assembly 2 during specimen collection and to act as a storage, transport, and/or drying container during specimen shipping. The illustrated housing container 13 also comprises a desiccant chamber 14 and a neck 15 extending from the desiccant chamber 14 the neck 15 having said opening 16 providing communication through the neck 15 and into the desiccant chamber 14, wherein said first stopper structure 10a and/or said second stopper structure 10b are insertable into the opening 16 of the neck 15, which is tapered to form a seat 17 for one or both stopper structures 10a and 10b.

The illustrated housing container 13 also comprises a swab isolation region 18 in the desiccant chamber 14. It will be appreciated that the opening 16 communicates through the neck 15 and into the swab isolation region 18 of the desiccant chamber 14. The swab isolation region 18 is aligned with the neck 15 to permit insertion of the first and second swabs 5a and 5b through the opening 16, through the neck 15, and into the swab isolation region 18, without any part of the housing container 13 contacting the first and second swabs 5a and 5b.

The illustrated housing container 13 also comprises a desiccant holding region 19 on at least one sidewall of the desiccant chamber 14, the desiccant holding region 19 configured to retain at least one desiccant packet 20 therein to absorb moisture from a specimen collected on the first and second swabs 5a and 5b.

The illustrated housing container 13 also comprises a base cap 21 on the desiccant chamber 14, wherein the base cap 21 is optionally openable and closeable and is optionally configured to permit removal of the desiccant packet 20 from the desiccant holding region 19 and insertion of the desiccant packet 20 into the desiccant holding region 19 while the first and second swabs 5a and 5b are in the swab isolation region 18 of the desiccant chamber 14.

The illustrated housing container 13 also comprises one or more retaining structures 22 in the desiccant chamber 14, the retaining structures 22 being configured to hold the desiccant packet 20 in the desiccant holding region 19 and away from contact with the first and second swabs 5a, and 5b. The retaining structures 22 may comprise rigid flanges extending from opposed sidewalls of the desiccant chamber 14. The retaining structures 22 may comprise flexible retainers extending downwardly from a top wall of the desiccant chamber 14. The retaining structures 22 may comprise flexible projections extending upwardly from the optionally openable and closeable base cap 21. The retaining structures 22 may comprise flexible projections extending both downwardly from the top wall and inwardly from opposed sidewalls of the desiccant chamber 14.

To establish and maintain a chain of custody of a sample collected using the specimen collector device 1, it may be marked with identification indicia which is unique to the device 1. Such indicia may be located on the housing container 13. The housing container 13 may also be imprinted with an arrow or marking with which to align the specimen collectors 3, thereby placing the first and second swabs 5a, and 5b equidistant from the desiccant packets 20.

In one aspect the present invention provides a specimen collection and transport device 1 comprising:
(a) a specimen collector assembly 2 comprising at least two specimen collectors 3 extending from a first side 9a of a container closure 9, the specimen collectors 3 comprising: (i) a first swab 5a, the swab comprising a first collection matrix 6a, connected to a first shaft 7a having a first shaft end with the first collection matrix 6a thereon and a second shaft end connected to the first side 9a of the container closure 9; (ii) a second swab 5b, the swab comprising a second collection matrix 6b, connected to a second shaft 7b having a first shaft end with the second collection matrix 6b thereon and a second shaft end connected to the first side 9a of the container closure 9, the container closure 9 having said first side 9a and a second side 9b, which are opposed sides of a central member 4, said first side 9a comprising a first stopper structure 10a and said second side 9b comprising a second stopper structure 10b or comprising a handle for the specimen collector assembly 2, the first and second swabs 5a, b being configured to simultaneously contact a specimen to collect a sample on the swabs, the first swab 5a being positioned to not contact the second swab 5b; and (iii) a first generally rigid tube 8a mounted coaxially on the first shaft 7a and a second generally rigid tube 8b mounted coaxially on the second shaft 7b, the tubes each having a first end connected to the first stopper structure 10a of the first side 9a of the container closure 9 and a second end optionally terminating at a shaft break point on each of said shafts 7a, b, said optional shaft break points being positioned along each of said shafts 7a, b at a location sufficiently spaced from each of said swabs 5a, b to permit the entire swab to be separated from the shaft when the shaft is broken at said shaft break point; and
(b) a housing container 13 for holding, drying, and transporting the first and second swabs 5a, b, the housing container 13 comprising: (i) a desiccant chamber 14; (ii) a neck 15 extending from the desiccant chamber 14 the neck 15 having an opening 16 providing communication through the neck 15 and into the desiccant chamber 14, wherein said first stopper structure 10a and/or said second stopper structure 10b are insertable into the opening 16, which communicates through the neck 15 and into the swab isolation region 18 of the desiccant chamber 14 and which opening 16 is tapered to form a seat 17 for one or both stopper structures 10a, b; (iii) a swab isolation region 18 in the desiccant chamber 14 the swab isolation region 18 aligned with the neck 15 to permit insertion of the first and second swabs 5a, b through the opening 16, through the neck 15, and into the swab isolation region 18; (iv) a desiccant holding region 19 on at least one sidewall of the desiccant chamber 14, the desiccant holding region 19 configured to retain at least one desiccant packet 20 therein to absorb moisture from a specimen collected on the first and second swabs 5a, b; and (v) a base cap 21 on the desiccant chamber 14, wherein the base cap 21 is optionally openable and closeable and is optionally configured to permit removal of the desiccant packet 20 from the desiccant holding region 19 and insertion of the desiccant packet 20 into the desiccant holding region 19 while the first and second swabs 5a, b are in the swab isolation region 18 of the desiccant chamber 14.

In certain embodiments of the device 1: (a) the first collection matrix 6a comprises a flocked swab; and (b) the second collection matrix 6b comprises a fibrous swab, a foam swab, or a mesh swab.

In certain embodiments of the device 1: (a) the first collection matrix 6a comprises said flocked swab comprising flocked polymeric fibers, flocked polyester fibers, and/or flocked nylon fibers; and (b) the second collection matrix 6b comprises said fibrous swab comprising spun or knitted fibers selected from the group consisting of cotton fibers, polymeric fibers, cellulose fibers, rayon fibers, polyester fibers, and calcium alginate fibers.

In certain embodiments of the device 1: said container closure 9 further comprises: (a) a first void hole 11a and a second void hole 11b located on the first side 9a of the container closure 9 into which the second shaft end of the first and second swabs 5a, b are positioned and into which the first ends of the first and second generally rigid tubes 8a, b are positioned; and (b) optionally at least one air hole 12 communicating through the first stopper structure 10a, through the central member 4, and through the second stopper structure 10b and/or through the handle of the container closure 9.

In certain embodiments the device 1 further comprises: one or more retaining structures 22 in the desiccant chamber 14 the retaining structures 22 configured to hold the desiccant packet 20 in the desiccant holding region 19 and away from contact with the first and second swabs 5a, b, wherein the retaining structures 22: (a) comprise rigid flanges extending from opposed sidewalls of the desiccant chamber 14; (b) comprise flexible retainers extending downwardly from a top wall of the desiccant chamber 14; (c) comprise flexible projections extending upwardly from the optionally openable and closeable base cap 21; or (d) comprise flexible projections extending both downwardly from the top wall and inwardly from opposed sidewalls of the desiccant chamber 14.

### Swab Types and Collection Matrix Materials

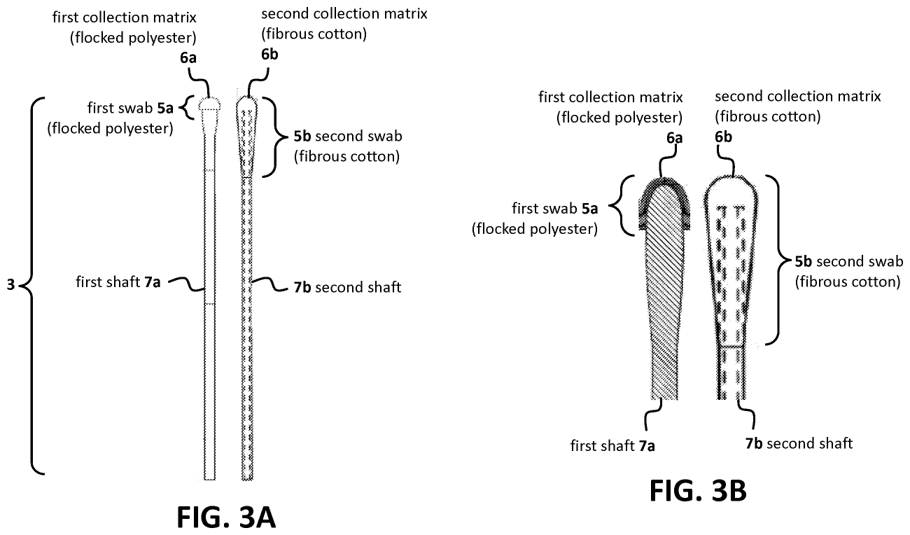

FIG. 3 shows an exemplary expanded cross-sectional view of specimen collectors 3, comprising shafts 7a and 7b with swabs 5a and 5b connected thereto, the first shaft ends of first and second shafts 7a and 7b terminating in the first and second swabs 5a and 5b with first and second collection matrices 6a and 6b thereon. It will be appreciated that the collection matrices 6a and 6b may be connected to the first and second swabs 5a and 5b or to the first shaft ends of first and second shafts 7a and 7b by any means known in the art, such as by electrostatic forces, embedding, coating, wrapping, gluing, or otherwise adhering the collection matrix material to the shaft end, thereby forming the swab. The first and second swabs 5a and 5b may be in a sterile condition or may be coated or impregnated with a chemical to attract or bind with a particular substance or coated to prevent migration of the sampled material too deeply into the swab matrix. The first and second swabs 5a and 5b may be utilized in dry form or may be pre-wetted by contacting with water, an aqueous solution, or any suitable liquid prior to contacting the specimen to be sampled.

The first and second swabs 5a and 5b may be provided in various forms and having various collection matrix materials depending on the suspected identity and the character of the specimen to be sampled. The sampled specimen may be a liquid, a liquid with suspended solids, a gel or a grease, a particulate or granular material, a flaked material, and so forth. Thus, the first and second swabs 5a and 5b may be chosen according to the type of specimen to be collected.

A significant advantage of the present invention is that the first and second swabs 5a and 5b may additionally be provided in various forms and having various collection matrix materials 6a and 6b depending on the type of forensic testing to be performed on the collected sample. Samples collected from crimes scenes may be subjected to forensic testing by methods including forensic analysis, chemical analysis, bioanalytical analysis, and/or DNA analysis for identification or for association with a particular individual. Forensic analysis, such as DNA analysis, may be performed by a rapid field-testing method or by a conventional standard laboratory test. Therefore, different first and second swab matrices 6a and 6b may be chosen based on their compatibility with two different testing methods, according to need.

Typical fibrous swabs, such as fibrous cotton swabs are generally compatible with standard laboratory DNA tests; however, they are not compatible with certain rapid DNA testing methods, that use smaller volumes of liquid and/or which require faster sample off-rates than conventional cotton swabs typically provide. Thus, it can be appreciated that the two swab collection matrices 6a and 6b may be chosen based on test method compatibility needs so that each collected sample may be analyzed by a different testing method, as needed. For example, the two swab collection matrices 6a and 6b may include a fibrous cotton swab matrix and a flocked swab matrix, which are compatible with standard laboratory DNA testing methods and modern rapid DNA field testing methods, respectively.

Generally, the first and second swabs 5a and 5b may be formed of various matrix material types, such as a fibrous material, a flocked material, various kinds of foam, sponge, or porous materials, a fabric, a paper, a netting material, a spun material, a knitted material, mesh material, or the like. Collection matrix materials 6a and 6b may include cotton, cellulose, calcium alginate, microfiber, polymeric, polyester, nylon, rayon, polyethylene, Dacron (polyethylene terephthalate), dissolvable polymers, bicomponent fibers, polypropylene, polyurethane, polyacrylonitrile, polylactic acid, polyester, nylon, or polyester fibers.

Fibrous swabs may include fibrous matrix materials such as cotton, cellulose, rayon, polyester, or the like. Flocked swabs may include flocked fiber matrix materials such as microfibers, polymeric fibers, polyester fibers, nylon fibers, rayon fibers, polyethylene fibers, polyethylene terephthalate fibers, dissolvable polymeric fibers, bicomponent fibers, polypropylene fibers, polyurethane fibers, polyacrylonitrile fibers, and polylactic acid fibers.

The illustrated first swab 5a of FIG. 3 includes a flocked first collection matrix 6a. The illustrated second swab 5b of FIG. 3 includes a non-flocked second collection matrix 6b. In certain embodiments of the device 1, the first collection matrix 6a and the second collection matrix 6b each comprises a swab matrix independently selected from a Group (I), consisting of a flocked swab matrix, a fibrous swab matrix, a foam swab matrix, a spun swab matrix, a knitted swab matrix, a mesh swab matrix, a cotton swab matrix, a cellulose swab matrix, a calcium alginate swab matrix, a microfiber swab matrix, a polymeric swab matrix, a polyester swab matrix, a nylon swab matrix, a rayon swab matrix, a polyethylene swab matrix, a polyethylene terephthalate swab matrix, a swab matrix comprising dissolvable polymers, a swab matrix comprising bicomponent fibers, a polypropylene swab matrix, a polyurethane swab matrix, a polyacrylonitrile swab matrix, and a polylactic acid swab matrix; and the swab matrix of the first collection matrix 6a and the second collection matrix 6b are different.

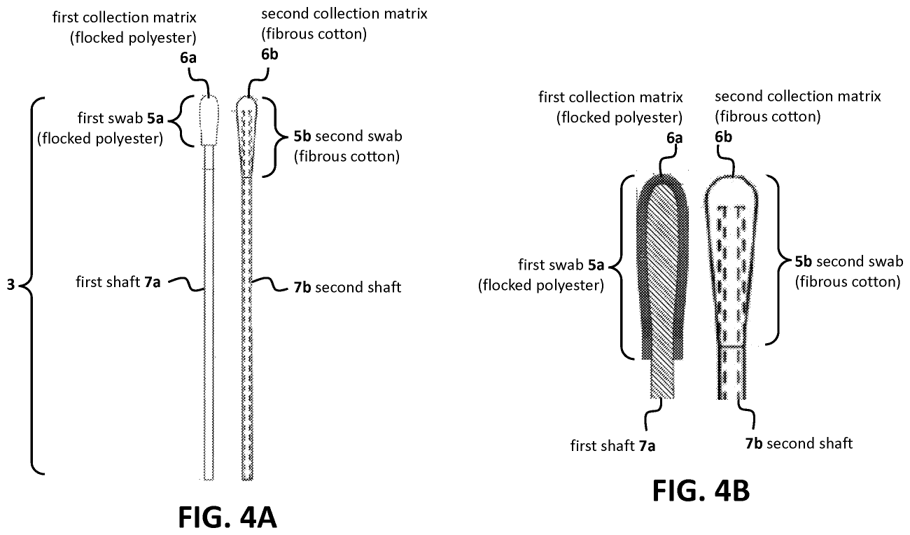

FIG. 4 shows an exemplary expanded cross-sectional view of swab shaft 7a and 7b terminating in swabs 5a and swab 5b, respectively, with collection matrices 6a and 6b thereon. In certain embodiments of the device 1, as exemplified in non-limiting FIG. 3 and non-limiting FIG. 4, the first swab 5a is a flocked polyester swab comprising a flocked polyester collection matrix 6a and the second swab is a fibrous cotton swab 5b comprising a fibrous cotton collection matrix 6b.

In certain embodiments of the device 1, the first collection matrix 6a may comprise said flocked swab matrix; and the second collection matrix 6b may comprise a non-flocked swab matrix selected from said Group (I). In certain embodiments of the device 1, the first collection matrix 6a may comprise said flocked swab matrix; and the second collection matrix 6b may comprise said fibrous swab matrix, said foam swab matrix, said spun swab matrix, said knitted swab matrix, or said mesh swab matrix. In certain embodiments of the device 1, the first collection matrix 6a may comprise said flocked swab matrix comprising one or more fibers selected from the group consisting of microfibers, polymeric fibers, polyester fibers, nylon fibers, rayon fibers, polyethylene fibers, polyethylene terephthalate fibers, dissolvable polymeric fibers, bicomponent fibers, polypropylene fibers, polyurethane fibers, polyacrylonitrile fibers, and polylactic acid fibers; and the second collection matrix 6b may comprise said fibrous swab matrix, said foam swab matrix, said spun swab matrix, said knitted swab matrix, or said mesh swab matrix comprising one or more fibers selected from the group consisting of cotton fibers, cellulose fibers, calcium alginate fibers, microfibers, polymeric fibers, polyester fibers, nylon fibers, rayon fibers, polyethylene fibers, polyethylene terephthalate fibers, dissolvable polymeric fibers, bicomponent fibers, polypropylene fibers, polyurethane fibers, polyacrylonitrile fibers, and polylactic acid fibers. In certain embodiments of the device 1, the first collection matrix 6a comprises said flocked swab matrix comprising polyester fibers and/or nylon fibers; and the second collection matrix 6b comprises said fibrous swab matrix, said spun swab matrix, said knitted swab matrix, or said mesh swab matrix comprising cotton fibers. In certain embodiments of the device 1, the first collection matrix 6a comprises said flocked swab matrix comprising polyester fibers and/or nylon fibers; and the second collection matrix 6b comprises said spun swab matrix comprising cotton fibers.

In certain embodiments of the device 1, the fibrous cotton collection matrix is compatible with traditional laboratory tests and with certain rapid DNA tests, which require sample off-rates typically provided by conventional cotton swabs. In certain embodiments of the device 1, the flocked polymeric collection matrix comprising flocked nylon or flocked polyester fibers is compatible with traditional laboratory tests and is compatible with certain newer model rapid DNA tests that use smaller volumes of liquid and/or require faster sample off-rates than conventional cotton swabs typically provide.

In certain embodiments of the device 1, the first collection matrix 6a and the second collection matrix 6b are compatible with a laboratory DNA test, a laboratory chemical test, any laboratory test, a rapid DNA test, a rapid chemical test, and/or any rapid field test. In certain embodiments of the device 1, the first collection matrix 6a is compatible with at least said rapid DNA test, said rapid chemical test, or any rapid field test; and the second collection matrix 6b is compatible with at least said laboratory DNA test, said laboratory chemical test, or any laboratory test. In certain embodiments of the device 1, the first collection matrix 6a is compatible with at least said rapid DNA test, said rapid chemical test, or any rapid field test that uses smaller amounts of liquid than previous iterations of said rapid test and/or which require faster sample off-rates than conventional cotton swabs typically provide; and the second collection matrix 6b is compatible with at least said laboratory DNA test, said laboratory chemical test, or any laboratory test.

In certain embodiments of the device 1, the one or more collected samples on the swabs 5a and 5b comprise (i) two samples of the same specimen, (ii) a sample of the specimen and a sample of an adjacent specimen, (iii) a sample of the specimen and a control sample, or (iv) two control samples.

It can be appreciated that samples of the specimens that are collected onto the first and second collection matrices 6a and 6b of the first and second swabs 5a and 5b will need to be eluted or “released” from the first and second collection matrices 6a and 6b prior to being detected, identified, or quantified by forensic testing. Sample release may occur at the sample collection site, such as for during rapid forensic field testing. Sample release may occur after storing, transporting, and/or drying the sample, such as during standard laboratory testing.

It can be appreciated that sample release rates, (i.e., the amount of sample released from the collection matrix over a specified period of time) for any given collected sample will vary based on the swab type and collection matrix material type. More rapid sample release rates are generally compatible with rapid field testing and may also be compatible with standard laboratory testing. Slower sample release rates are generally compatible with standard laboratory testing and may not be compatible with rapid field testing.

In certain embodiments of the device 1, the collected sample on the first collection matrix 6a comprises a first sample release rate and the sample on the second collection matrix 6b comprises a second sample release rate.

In certain embodiments of the device 1, the sample on the first collection matrix 6a comprises said first sample release rate and the sample on the second collection matrix 6b comprises said second sample release rate, wherein said first and second sample release rates are determined when submerged in an aqueous or organic liquid or when subjected to a chemical analysis and/or a DNA analysis for identification or for association with a particular individual.

In certain embodiments of the device 1, the first sample release rate does not equal the second sample release rate. In certain embodiments of the device 1, the first sample release rate is faster than the second sample release rate. In certain embodiments of the device 1, the first sample and the second sample release rates are sufficiently fast to be compatible with said laboratory DNA test, said laboratory chemical test, any laboratory test, said rapid DNA test, said rapid chemical test, or any rapid field test. In certain embodiments of the device 1, the first sample release rate is sufficiently fast to be compatible with at least said rapid DNA test, said rapid chemical test, or any rapid field test; and the second sample release rate is sufficiently fast to be compatible with at least said laboratory DNA test, said laboratory chemical test, or any laboratory test. In certain embodiments of the device 1, the first sample release rate is sufficiently fast to be compatible with at least said rapid DNA test, said rapid chemical test, or any rapid field test that uses smaller amounts of liquid than previous iterations of said rapid test and/or which require faster sample off-rates than conventional cotton swabs typically provide; and the second sample release rate is sufficiently fast to be compatible with at least said laboratory DNA test, said laboratory chemical test, or any laboratory test.

### Methods of Specimen Collection

In another aspect, the present invention provides a method of specimen collection comprising the steps of: (a) applying one or both swabs of a specimen collection device 1 according to any of the foregoing to at least one specimen, wherein the specimen collection device comprises a first swab 5a comprising a first collection matrix 6a, and a second swab 5b comprising a second collection matrix 6b; and (b) collecting a sample of the at least one specimen onto one or both swabs, thereby providing a first sample on the first collection matrix 6a and/or a second sample on the second collection matrix 6b.

In exemplary embodiments of the method the first collection matrix 6a of the first swab 5a and the second collection matrix 6b of the second swab 5b are simultaneously or subsequently applied to a specimen to collect a sample of the specimen.

It will be appreciated that the term “swab” refers to shaft end and collection matrix thereon. It will also be appreciated that the term “collection matrix” refers to the collection matrix material itself. It will also be appreciated that the steps of (i) application of the swab to a specimen and (ii) application of the collection matrix to a specimen are interchangeable.

In some exemplary embodiments of the method: the first swab 5a and the second swab 5b are simultaneously or subsequently applied to: (a) two adjacent areas on the same specimen; (b) a same area on the same specimen; (c) areas on two adjacent specimens; (d) a specimen and an adjacent control area; (e) two adjacent control areas.

In some exemplary embodiments of the method said one or more samples on the swabs comprise: (i) two samples of the same specimen, (ii) a sample of the specimen and a sample of an adjacent specimen, (iii) a sample of the specimen and a control sample, or (iv) two control samples.

In some exemplary embodiments the method further comprises the steps of: (a) analyzing the first sample on the first collection matrix 6a for data regarding the specimen or the control; and/or (b) analyzing the second sample on the second collection matrix 6b for data regarding the specimen or the control.

In some exemplary embodiments the method further comprises the steps of: (a) analyzing the first sample on the first collection matrix 6a and/or the second sample on the second collection matrix 6b using a laboratory DNA test, a laboratory chemical test, any laboratory test, a rapid DNA test, a rapid chemical test, and/or a rapid field test for data regarding the specimen or the control, optionally wherein the rapid DNA test, the rapid DNA test, and/or the rapid field test uses smaller amounts of liquid than previous iterations of said rapid test and/or requires faster sample off-rates than conventional cotton swabs typically provide; (b) analyzing the first sample on the first collection matrix 6a using said rapid DNA test, said rapid chemical test, or said rapid field test for data regarding the specimen or the control, wherein the rapid DNA test, the rapid DNA test, and/or the rapid field test uses smaller amounts of liquid than previous iterations of said rapid test and/or requires faster sample off-rates than conventional cotton swabs typically provide; (c) analyzing the second sample on the second collection matrix 6b using a laboratory DNA test, a laboratory chemical test, or a laboratory test for data regarding the specimen to provide specimen data; or (d) a combination of (b) and (c).

In some exemplary embodiments the method further comprises the steps of: (a) pre-wetting the one or more specimens with sterile water, water, a liquid, or a solution optionally comprising one or more surfactants prior to applying the swabs to the specimen; (b) pre-wetting one or both of said first and second collection matrices 6a and 6b with sterile water, water, a liquid, or a solution optionally comprising one or more surfactants prior to applying the swabs to the specimen; (c) inserting both swabs 5a, b into the neck 15 of the housing container 13 to place the swabs in the swab isolation region 18 of the desiccant chamber 14; (d) aligning the first swab 5a or second swab 5b with an indicator located on the neck 15 of the housing container 13, wherein both swabs are positioned within the swab isolation region 18 in a position that provides uniform separation between each of the swabs and the desiccant packets 20; (e) inserting one or more desiccant packets 20 into the desiccant holding region 19, wherein the one or more desiccant packets 20 are held in place and away from contact with the first and second swabs 5a and 5b by said retaining structures 22; (f) drying both swabs within the desiccant chamber 14; (g) during the step of drying both swabs, optionally replacing one or more of said desiccant packets 20 in the desiccant holding region 19; (h) transporting the swabs to a second location; or (i) any combination of (a)-(h).

In some exemplary embodiments of the method:
(a) the first collection matrix 6a and the second collection matrix 6b each comprises a swab matrix selected from a Group (I), consisting of a flocked swab matrix, a fibrous swab matrix, a foam swab matrix, a spun swab matrix, a knitted swab matrix, a mesh swab matrix, a cotton swab matrix, a cellulose swab matrix, a calcium alginate swab matrix, a microfiber swab matrix, a polymeric swab matrix, a polyester swab matrix, a nylon swab matrix, a rayon swab matrix, a polyethylene swab matrix, a polyethylene terephthalate swab matrix, a swab matrix comprising dissolvable polymers, a swab matrix comprising bicomponent fibers, a polypropylene swab matrix, a polyurethane swab matrix, a polyacrylonitrile swab matrix, and a polylactic acid swab matrix; wherein the swab matrix of the first collection matrix 6a and the second collection matrix 6b are different; (b) the first collection matrix 6a comprises said flocked swab matrix; and the second collection matrix 6b comprises any swab matrix selected from said Group (I) which is a non-flocked swab matrix; (c) the first collection matrix 6a comprises said flocked swab; and the second collection matrix 6b comprises said fibrous swab matrix, said foam swab matrix, said spun swab matrix, said knitted swab matrix, or said mesh swab matrix; (d) the first collection matrix 6a comprises said flocked swab matrix comprising one or more fibers selected from the group consisting of microfibers, polymeric fibers, polyester fibers, nylon fibers, rayon fibers, polyethylene fibers, polyethylene terephthalate fibers, dissolvable polymeric fibers, bicomponent fibers, polypropylene fibers, polyurethane fibers, polyacrylonitrile fibers, and polylactic acid fibers; and the second collection matrix 6b comprises said fibrous swab matrix, said foam swab matrix, said spun swab matrix, said knitted swab matrix, or said mesh swab matrix comprising one or more fibers selected from the group consisting of cotton fibers, cellulose fibers, calcium alginate fibers, microfibers, polymeric fibers, polyester fibers, nylon fibers, rayon fibers, polyethylene fibers, polyethylene terephthalate fibers, dissolvable polymeric fibers, bicomponent fibers, polypropylene fibers, polyurethane fibers, polyacrylonitrile fibers, and polylactic acid fibers; (e) the first collection matrix 6a comprises said flocked swab matrix comprising polyester fibers and/or nylon fibers; and the second collection matrix 6b comprises said fibrous swab matrix, said spun swab matrix, said knitted swab matrix, or said mesh swab matrix comprising cotton fibers; or (f) the first collection matrix 6a comprises said flocked swab matrix comprising polyester fibers and/or nylon fibers; and (g) the second collection matrix 6b comprises said spun swab matrix comprising cotton fibers.

In some exemplary embodiments of the method: (a) the first collection matrix 6a comprises said flocked swab comprising flocked polymeric fibers, flocked polyester fibers, and/or flocked nylon fibers; and (b) the second collection matrix 6b comprises said fibrous swab comprising spun or knitted fibers selected from the group consisting of cotton fibers, polymeric fibers, cellulose fibers, rayon fibers, polyester fibers, and calcium alginate fibers.

### LEGEND

Specimen collection device 1 with dual collection matrices;
specimen collector assembly 2 with dual collection matrices;
specimen collectors 3;
central member 4 of closure 9;
first swab 5a (shaft end and collection matrix 6a);
second swab 5b (shaft end and collection matrix 6b);
first collection matrix 6a;
second collection matrix 6b;
first shaft 7a;
second shaft 7b;
first generally rigid tube (break-off tube) 8a;
second generally rigid tube (break-off tube) 8b;
container closure 9;
first side 9a of closure 9;
second side 9b of closure 9;
first and second stopper structures 10a and 10b;
first and second void holes 11a and 11b;
air hole(s) 12;
housing container 13; for specimen drying, and transport.
desiccant chamber 14;
neck of housing 15;
opening 16 through neck 15 into desiccant chamber 14;
seat for stopper 17;
swab isolation region 18;
desiccant holding region 19;
desiccant packets 20;
desiccant chamber base cap 21;
retaining structures (flexible or rigid guards) 22.

The methods and device illustratively disclosed herein suitably may be practiced in the absence of any element which is not specifically disclosed herein and/or any element specifically disclosed herein. Exemplary embodiments of the invention and its advantages are further disclosed in the following examples.

### EXAMPLES

The examples provided herein are for illustrative purposes so that the invention may be more fully understood. These examples should not be construed as limiting the invention in any way.

### Example 1: Evaluation of Specimen Collector with Dual Collection Matrices

### Dual Matrix Test Device

An embodiment of the specimen collector device 1 with dual collection matrices, comprising specimen collector assembly 2 and housing container 13 according to FIG. 1, hereinafter “dual matrix test device”, was evaluated as set forth below.

The embodiment of the dual matrix test device was a single collection device with a specimen collector assembly having two specimen collectors terminating in two collection swabs, each swab containing a different collection matrix. More specifically, the embodiment of the dual matrix test device was a single collection device with a specimen collector assembly having a flocked polyester swab containing a flocked polyester matrix and a cotton swab containing a cotton matrix. The total length and stiffness was approximately the same for each specimen collector so that the flocked polyester swab and the cotton swab could be simultaneously pressed against a flat specimen surface while applying approximately the same contact force between each swab and the surface.

The dual matrix test device was evaluated for collecting samples of buccal specimens or blood specimens. The collected samples were then tested via Rapid DNA analysis and Standard laboratory procedures to determine if DNA profiles can be obtained with both methods. Samples collected by the flocked polyester swabs were tested using Rapid DNA analysis. Samples collected by the cotton swabs were tested using standard laboratory testing protocols.

MATERIALS AND METHODS

### Sample Collection

A single collection step was performed by applying both collection swabs of the dual matrix test device to a buccal specimen or a blood specimen and simultaneously collecting a sample of the specimen on each collection matrix. In this manner, samples of single-source buccal or blood specimens were collected onto flocked polyester swabs and cotton swabs of the dual matrix test devices.

Buccal samples were self-collected from five donors with IRB-approved consent. The donors swabbed the inner lining of one cheek ten times with one side of both swabs, rotated the collection device and swabbed the inner lining of the same cheek another ten times with the other side of the swabs.

Blood was commercially sourced via Interstate Blood Bank. Five replicates of 200 μL of neat blood from one donor were spotted onto glass and brick and allowed to dry for 72 h. Two to three drops of sterile water were applied to one side of each swab of the dual matrix test device, and then the dried bloodstains were sampled ten times with the wet side of each swab followed by ten times with the dry side, collecting as much blood as possible.

The bouquet method was utilized for all buccal and blood sample collection, where biological material is collected together, side-by-side, during the swabbing motion with both swabs as set forth by the Non-CODIS Rapid DNA Best Practices/Outreach and Courtroom Considerations Task Group (2019) and described in Non-CODIS Rapid DNA Considerations and Best Practices for Law Enforcement Use (https://le.fbi.gov/file-repository/non-codis-rapid-dna-best-practices-092419.pdf/view, accessed Jan. 17, 2025, the entirety of which is incorporated by reference herein). Collected samples were repacked in the housing chamber of the dual matrix test device with desiccant and allowed to dry for a minimum of overnight prior to processing.

### Testing of Collected Samples

Evaluation of collected samples was performed to provide proof of concept for compatibility of the dual matrix test device with Rapid DNA analysis and standard laboratory testing (Standard) procedures.

Samples collected by the flocked polyester swabs were tested by Rapid DNA analysis using an Applied BioSystems™ RapidHIT™ ID System (Rapid) with an Applied BioSystems™ RapidHIT™ ID ACE GlobalFiler™ Express (ACE) sample cartridge. Data was analyzed using SoftGenetics GeneMarker® HID analysis software v2.9.0 (SOPs BTF00478 and BTF00475).

Samples collected by the cotton swabs were tested using standard laboratory testing protocols. For standard laboratory testing, the associated cotton swab from the same dual matrix test device was extracted on the Hamilton VANTAGE (SOP BT00608), quantified in a half-reaction volume with Applied BioSystems™ Quantifiler™ Trio (SOP BTF00242), amplified with Applied BioSystems™ GlobalFiler PCR Amplification Kit in a 25 μL reaction at 29 cycles targeting 0.75 ng DNA (SOP BT00471), and then analyzed by capillary electrophoresis on an Applied BioSystems™ 3500xL Genetic Analyzer (SOP BT00444).

Data analysis and interpretation were performed using Applied BioSystems™ GeneMapper ID-X Software v1.6 (SOPs BT00431, BT00051 and BT00270). Analysis parameters for Rapid (SOP BTF00475) and standard (SOP BT00431) processing are shown in Table 1.

TABLE 1
Analytical thresholds, stochastic thresholds, and peak
height ratio for rapid and standard processing.

| | Rapid - GeneMarker | | | Standard - GeneMapper ID-X | | |
|---|---|---|---|---|---|---|
| | Analytical | Stochastic | | Analytical | Stochastic | |
| | Threshold | Threshold | Peak Height | Threshold | Threshold | Peak Height |
| Locus | (RFU) | (RFU) | Ratio | (RFU) | (RFU) | Ratio* |
| D3S1358 | 35 | 91 | 40% | 125 | 600 | 60% |
| vWA | 35 | 91 | 40% | 125 | 600 | 60% |
| D16S539 | 35 | 91 | 40% | 125 | 600 | 60% |
| CSF1PO | 35 | 91 | 40% | 125 | 600 | 60% |
| TPOX | 35 | 105 | 40% | 125 | 600 | 60% |
| Y indel | 35 | 35 | 40% | 125 | 600 | 60% |
| AMEL | 35 | 91 | 40% | 125 | 600 | 60% |
| D8S1179 | 35 | 91 | 40% | 125 | 600 | 60% |
| D21S11 | 35 | 91 | 40% | 125 | 600 | 60% |
| D18S51 | 35 | 91 | 40% | 125 | 600 | 60% |
| DYS391 | 35 | 35 | 40% | 125 | 600 | 60% |
| D2S441 | 35 | 91 | 40% | 125 | 600 | 60% |
| D19S433 | 35 | 91 | 40% | 125 | 600 | 60% |
| TH01 | 35 | 140 | 40% | 125 | 600 | 60% |
| FGA | 35 | 91 | 40% | 125 | 600 | 60% |
| D22S1045 | 35 | 91 | 40% | 125 | 600 | 60% |
| D5S818 | 35 | 91 | 40% | 125 | 600 | 60% |
| D13S317 | 35 | 91 | 40% | 125 | 600 | 60% |
| D7S820 | 35 | 91 | 40% | 125 | 600 | 60% |
| SE33 | 35 | 105 | 40% | 125 | 600 | 60% |
| D10S1248 | 35 | 91 | 40% | 125 | 600 | 60% |
| D1S1656 | 35 | 91 | 40% | 125 | 600 | 60% |
| D12S391 | 35 | 105 | 40% | 125 | 600 | 60% |
| D2S1338 | 35 | 105 | 40% | 125 | 600 | 60% |

*Up to four loci can have balance less than 60%, three of which must be 50% or greater and the remaining locus must be 40% or greater.

### Data Analysis Metrics:

DNA Quantity-DNA concentration (ng/μl) of the Quantifiler Trio small autosomal target.

DNA Degradation Index (DI)—The ratio between the small and large autosomal targets in Quantifiler Trio was used to determine if the DNA in the sample was degraded. A DI<1 typically indicates the DNA was not likely degraded. A DI between 1 and 10 typically indicates slight to moderate DNA degradation that may affect STR amplification. A DI>10 typically indicates that the sample may have been severely degraded, as set forth in Life Technologies, (2018), Quantifiler HP and Trio DNA Quantification Kits User Guide, Publication Number 4485354, Revision H (retrieved from https://assets.thermofisher.com/TFS-Assets/LSG/manuals/4485354.pdf, accessed Jan. 17, 2025).

Average Profile Peak Height—The sum of all peak heights observed divided by the maximum number of alleles possible. Only autosomal loci were included in this calculation.

Heterozygote Balance—The smaller peak height at each autosomal STR locus was divided by the larger peak height observed within the same locus.

Percent Complete Profile—The number of alleles observed divided by the number of alleles expected in a donor profile.

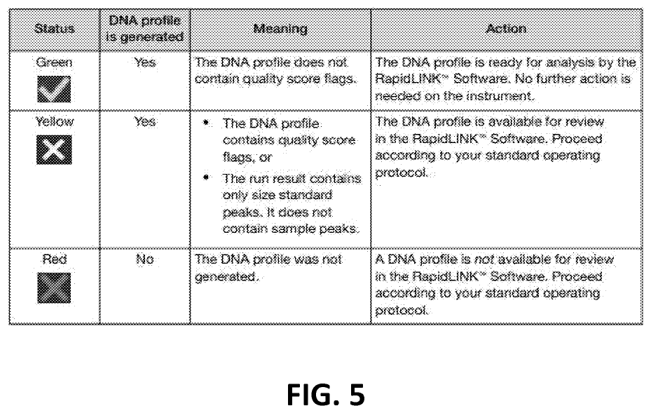

Rapid Run Result Status—After the sample cartridge was removed from the instrument, the run result was displayed. The meaning of each status, as set forth in Applied Biosystems (2022) RapidHIT™ ID System v1.3.3 User Guide, Publication Number MAN0025746, Revision C.O. (https://assets.thermofisher.com/TFS-Assets/LSG/manuals/MAN0025746-RapidHITID-v1.3.3-ROW-UG.pdf, accessed Jan. 28, 2025) is shown in FIG. 5.

### Results

Results from Flocked Polyester Swabs

Results from samples collected by the flocked polyester swabs, analyzed on the Rapid with ACE cartridge are shown below in Table 2 for all samples. All buccal and blood samples from the flocked polyester swabs were of sufficiently high quality to generate database-ready files (passing run status with green check marks) with 100% complete and concordant profiles and exceeded the heterozygote balance threshold of 40%. All samples provided peak heights that met required analytical and stochastic thresholds. One buccal sample (2F-RD2024-7) required an artifact edit at the Y indel locus. The Rapid system does not flag Y-STR markers, as they are not included in the CODIS core loci; therefore, this sample generated a database-ready file.

TABLE 2
Number of complete profiles and average profile peak
height for flocked polyester swabs run on the Rapid.

| | | Number of | Profile Peak Height |
|---|---|---|---|
| | Number of | Complete | (RFU) Average ± |
| Swab and Sample Type | Samples | Profiles | Standard Deviation |
| Flocked - Buccal | 5 | 5 | 2424 ± 1215 |
| Flocked - Blood on glass | 5 | 5 | 492 ± 187 |
| Flocked - Blood on brick | 5 | 5 | 586 ± 184 |

Results from Cotton Swabs

Results of the cotton swabs processed with standard laboratory procedures are provided below in Table 3. All samples provided ample quantities of DNA for downstream processing and provided average DIs of less than 1, indicating DNA is not likely degraded.

TABLE 3
Average DNA quantity and Degradation Index for
cotton swabs processed with standard procedures

| | DNA Quantity (ng/μL) | Degradation Index |
|---|---|---|
| | Average ± Standard | Average ± Standard |
| Swab and Sample Type | Deviation | Deviation |
| Cotton - Buccal | 33.43 ± 18.57 | 0.86 ± 0.22 |
| Cotton - Blood on glass | 7.02 ± 3.61 | 0.76 ± 0.05 |
| Cotton - Blood on brick | 2.88 ± 2.06 | 0.71 ± 0.06 |

Amplification results of the cotton swabs processed with standard laboratory procedures are provided below in Table 4. All buccal and blood samples provided 100% complete and concordant profiles and provided heterozygote balances that met internal forensic casework balance expectations. All buccal and blood samples provided peak heights that exceeded analytical and stochastic thresholds.

TABLE 4
Number of complete profiles and average profile peak height
for cotton swabs processed with standard procedures

| | | Number of | Profile Peak Height |
|---|---|---|---|
| | Number of | Complete | (RFU) Average ± |
| Swab and Sample Type | Samples | Profiles | Standard Deviation |
| Cotton - Buccal | 5 | 5 | 5642 ± 1327 |
| Cotton - Blood on glass | 5 | 5 | 6330 ± 1739 |
| Cotton - Blood on brick | 5 | 5 | 6472 ± 1813 |

### Conclusions

The data evaluated in this study provides support for compatibility of the inventive dual matrix test device and methods of use with the RapidHIT ID System using the RapidHIT ID ACE GlobalFiler Express sample cartridge and standard laboratory procedures. Complete and concordant profiles were obtained with the flocked swab on the Rapid and the cotton swab with standard laboratory procedures.

These results provide initial proof of concept that the inventive method and apparatus is highly effective for simultaneously collecting duplicate samples of buccal or blood specimens onto dual swab collection matrices (e.g. flocked polyester and fibrous cotton). These results also provide proof of concept that the samples collected on flocked polyester swabs are effectively analyzed by the rapid DNA field testing methods and the samples collected on fibrous cotton swabs are effectively analyzed by standard laboratory DNA testing procedures.

### Example 2: Evaluation of Specimen Collector with Dual Collection Matrices

The dual matrix test device of Example 1 was evaluated for collection efficiency against a cotton swab and a flocked swab from Puritan Medical Products.

Briefly, the dual matrix test device was a single collection device with a specimen collector assembly having a flocked polyester swab containing a flocked polyester matrix and a cotton swab containing a cotton matrix. The total length, shaft diameter, and stiffness was approximately the same for each specimen collector so that the flocked polyester swab and the cotton swab could be simultaneously pressed against a flat specimen surface while applying approximately the same contact force between each swab and the surface.

The dual matrix test device and Puritan swabs were used to collect samples of biological fluids (blood and saliva) from glass and cotton fabric substrates. Collection efficiencies were determined using Rapid DNA analysis technology and Standard laboratory procedures. Samples collected by the flocked polyester swabs were tested using Rapid DNA analysis. Samples collected by the cotton swabs were tested using standard laboratory testing protocols.

### Materials and Methods

### Sample Collection

Biological fluids (blood and saliva) were obtained and spotted onto glass and cotton t-shirt fabric surfaces according to Table 5. Blood was commercially sourced and was applied directly (neat) to cotton fabric and was diluted 1:1 with water before being applied to glass. Saliva was obtained from a volunteer donor with IRB-approved consent and was applied directly (neat) to both cotton and glass. After spotting, the biological fluids were allowed to dry overnight prior to collection, thereby producing blood and saliva stained surfaces.

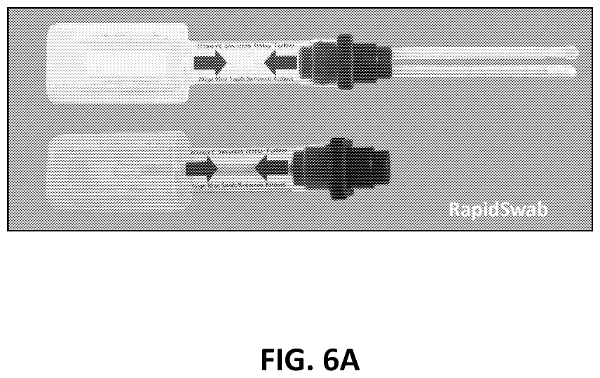

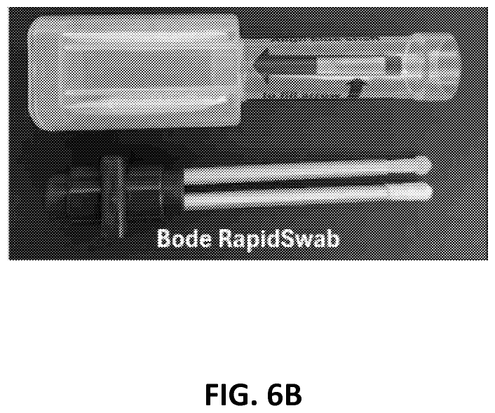

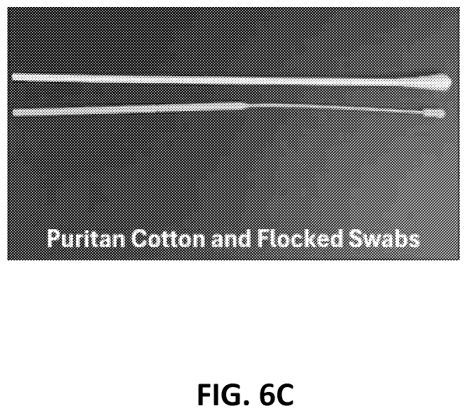

Samples of the blood and saliva specimens were then collected from the stained surfaces with the inventive dual matrix test device (RapidSwab, Bode Technology, Product Code SA-300-P, Lot 25282) using the bouquet method for sampling according to Example 1. Sequential and subsampling collection methods were used for sample collection with the separate cotton swabs (Puritan Medical Products, Catalog #25-806 2PC, Lot B474) and flocked swabs (Puritan Medical Products, Catalog #253318H, Lot S1590). Collection swab counts and methods are shown in Table 5. Collectors and swabs are shown in FIG. 6.

Prior to sample collection, two drops of water were applied to all cotton swabs, and one drop of water was applied to all flocked swabs. All stained surfaces were swabbed with the wet side of each swab ten times followed by the dry side ten times.

For the bouquet method, samples of biological material were collected from each stained surface together, side-by-side, onto both cotton and flocked matrices of the inventive dual matrix test device (RapidSwab) during the swabbing motion with both swabs. Afterwards, both swabs containing the collected samples were placed, side by side, into the housing container with desiccants and stored in a paper transport pouch.

Sequential sampling involved swabbing each stained surface first with a Puritan cotton swab and then swabbing the same stained surface with a Puritan flocked swab. Afterwards, each swab containing a collected sample was placed in its own swab box and stored in a paper transport pouch.

Subsampling collection involved swabbing each stained surface with a Puritan cotton swab, which was then placed in a swab box inside a paper transport pouch and allowed to dry overnight. The next day a Puritan flocked swab was used to subsample the collected sample from the cotton swab. Flocked swabs were pre-wet with one drop of water. Subsampling was performed by swabbing the cotton swab with the wet side of each flocked swab ten times followed by the dry side ten times. The flocked swab was then placed in a swab box inside a paper transport pouch and allowed to dry overnight.

TABLE 5
Surfaces, biological fluids, swabs, sampling materials, and
sampling methods used for the collection efficiency study.

| | | | RapidSwab | | Puritan | | Purtan | |
|---|---|---|---|---|---|---|---|---|
| | | | Bouquet | | Sequential | | Subsampling | |
| | Volume, | | # of | # of | # of | # of | # of | # of |
| | Biological | Number | Cotton | Flocked | Cotton | Flocked | Cotton | Flocked |
| Surface | Fluid | of Stains | Swabs | Swabs | Swabs | Swabs | Swabs | Swabs |
| Glass | 150 μL, | 30 | 10 | 10 | 10 | 10 | 10 | 10 |
| | 1:1 diluted blood | | | | | | | |
| Cotton Fabric | 150 μL, neat blood | 30 | 10 | 10 | 10 | 10 | 10 | 10 |
| Glass | 75 μL, neat saliva | 30 | 10 | 10 | 10 | 10 | 10 | 10 |
| Cotton Fabric | 75 μL, neat saliva | 30 | 10 | 10 | 10 | 10 | 10 | 10 |

### Testing of Collected Samples

All swabs with collected samples were allowed to dry for a minimum of overnight prior to laboratory processing.

Samples were tested using a standard laboratory testing protocol in which the collected sample was extracted from each swab on a Hamilton VANTAGE (SOP BT00608) and quantified in a half-reaction volume with Applied BioSystems™ Quantifiler™ Trio (SOP BTF00242). Mean values for DNA Quantity (ng/μL), DNA Degradation Index (DI), and Total DNA (ng) were determined. A t-test was used for comparison of mean quantification results, with p-values <0.05 indicating a statistically significant difference between the mean results.

### Data Analysis Metrics:

DNA Quantity-DNA concentration (ng/μL) of the Quantifiler Trio small autosomal target.

DNA Degradation Index (DI)—The ratio between the small and large autosomal targets in Quantifiler Trio was used to determine if the DNA in the sample was degraded. A DI<1 indicates the DNA was not likely degraded. A DI between 1 and 10 indicates slight to moderate DNA degradation that may affect STR amplification. A DI>10 indicates that the sample may have been severely degraded, as set forth in Life Technologies, (2018), Quantifiler HP and Trio DNA Quantification Kits User Guide, Publication Number 4485354, Revision H (retrieved from https://assets.thermofisher.com/TFS-Assets/LSG/manuals/4485354.pdf, accessed Jan. 17, 2025).

Total DNA (ng)—The DNA quantity (ng/μL) multiplied by the total elution volume of the extract.

### Results

Functionality of the swabs was assessed by the user during sampling. It was observed that the flimsiness of the Puritan flocked swab shaft made it difficult to apply appropriate pressure for sample collection from stained surfaces and subsampling of stains from cotton swabs. This was especially challenging when sampling DNA from the cotton fabric which shifted during sampling and did not provide a stable surface. Attempts were made to apply more pressure between the Puritan flocked swab and the stained surfaces; however, this only caused additional bending of the shaft with no additional pressure applied to the surface.

The design of the RapidSwab allowed for easy application appropriate and uniform pressure during sampling with both the cotton and flocked swab simultaneously. The total length, shaft diameter, and stiffness was approximately the same for each specimen collector so that the flocked polyester swab and the cotton swab could be simultaneously pressed against a flat specimen surface while applying approximately the same contact force between each swab and the surface.

Packaging the RapidSwab was more convenient since the swabs only needed to be placed into the housing container and then packaged in a paper transport pouch. The Puritan swabs required additional materials, since the swab boxes needed to be assembled before packaging into paper transport pouches.

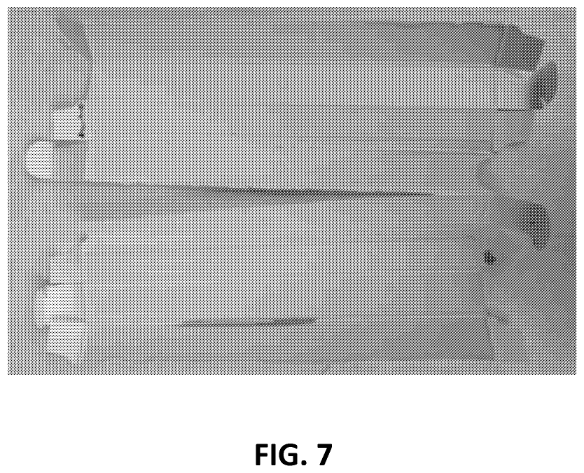

It was also observed that a portion of the collected blood was transferred from the Puritan swabs to the interior of the swab boxes. A picture of the blood-stained boxes is shown in FIG. 7. No visual transfer of blood from the inventive dual matrix test device (RapidSwab) was observed.

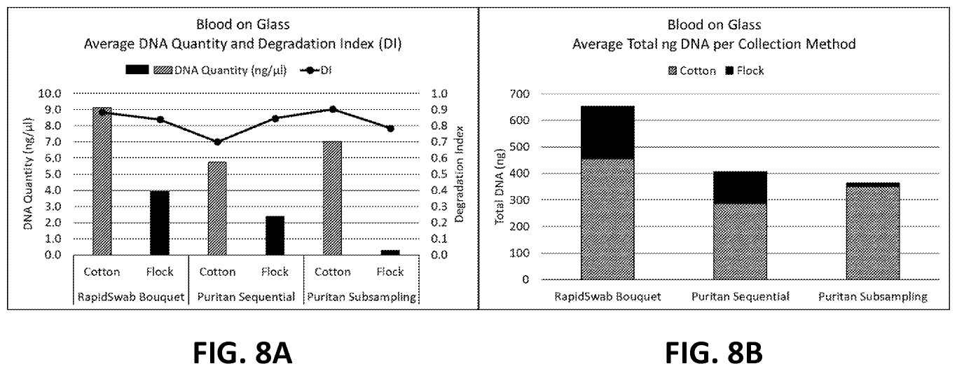

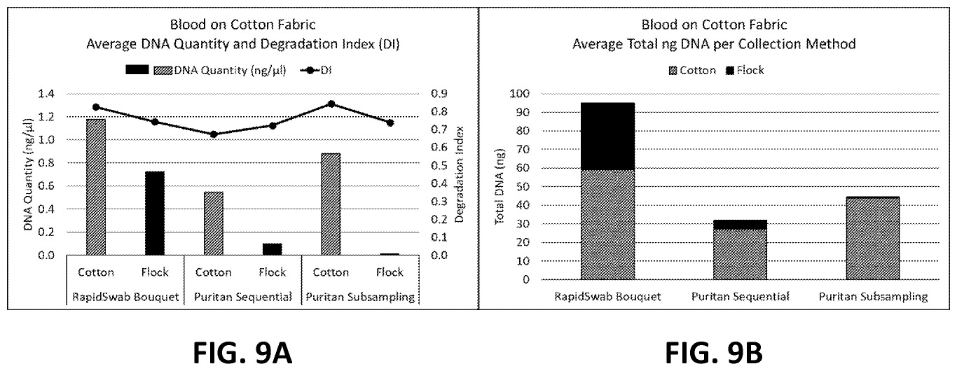

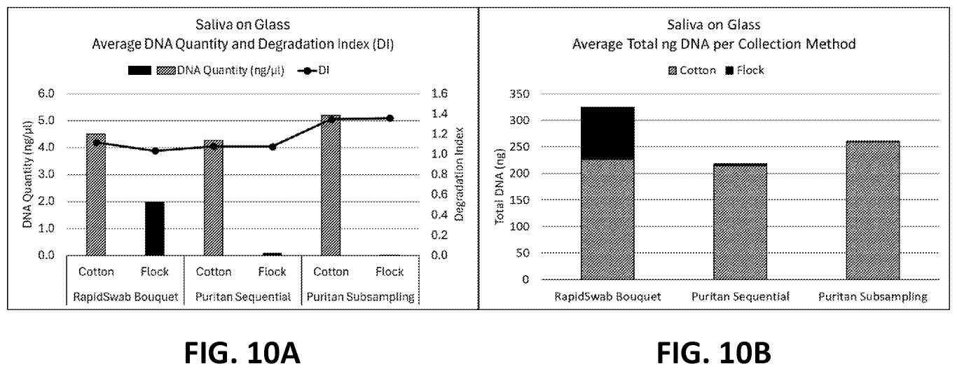

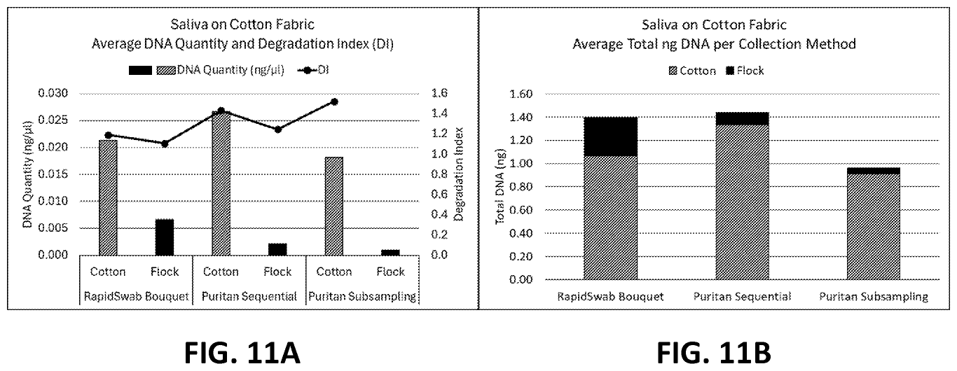

Results for DNA Quantity (ng/μL), DNA Degradation Index (DI), and Total DNA (ng) are shown in FIG. 8A-B, FIG. 9A-B, FIG. 10A-B, and FIG. 11A-B.

Results for samples collected from blood stained glass surfaces are shown in FIG. 8A-B. Results of FIG. 8A indicate that all cotton swab samples provided ample amounts of DNA. For the flocked swabs, the inventive dual matrix test device (RapidSwab) flocked swab provided 1.6× more DNA than the Puritan flocked swab using sequential collection; however, this difference was not statistically significant. The inventive dual matrix test device (RapidSwab) flocked swab provided 14× more DNA than the Puritan flocked swab using subsampling collection. This difference was statistically significant. The DI values for all samples remained under an average of 1, indicating no likely DNA degratation.

Results of FIG. 8B indicate that the inventive dual matrix test device (RapidSwab) collected more total ng of DNA with both swabs compared to sequential and subsampling methods using the Puritan swabs. The differences in means were statistically significant. While the total ng collected were 1.6× greater for the RapidSwab, the Puritan sequential method provided similar ratios of 70% total ng DNA coming from the cotton swab and 30% total ng DNA coming from the flocked swab, whereas subsampling provided a ratio of 96% from the cotton swab and 4% from the flocked swab.

Results for samples collected from blood stained cotton fabric surfaces are shown in FIG. 9A-B. Results of FIG. 9A indicate that all cotton swab samples provided ample amounts of DNA. For the flocked swabs, the inventive dual matrix test device (RapidSwab) flocked swab provided 7× more DNA than the Puritan flocked swab using sequential collection and 60× more DNA than the Puritan flocked swab using subsampling collection. Both differences were statistically significant. The DI values for all samples remained under an average of 1, indicating no likely DNA degratation.

Results of FIG. 9B indicate that the inventive dual matrix test device (RapidSwab) collected more total ng of DNA with both swabs compared to sequential and subsampling methods using the Puritan swabs. The differences in means were statistically significant. The proportion of total ng DNA varied across swabs: the RapidSwab consisted of 62% cotton and 38% flocked, Puritan sequential contained 85% cotton and 15% flocked, and Puritan subsampling was 99% cotton and 1% flocked.

Results for samples collected from saliva stained glass surfaces are shown in FIG. 10A-B. Results of FIG. 10A indicate that all cotton swab samples provided ample amounts of DNA. For the flocked swabs, the inventive dual matrix test device (RapidSwab) flocked swab provided 22× more DNA than the Puritan flocked swab using sequential collection and 116× more DNA than the Puritan flocked swab using subsampling collection. Both differences were statistically significant. The DI values for all samples remained under an average of 1, with the exception of Puritan cotton and flocked swabs using subsampling collection indicating partial DNA degratation for those samples.

Results of FIG. 10B indicate that the inventive dual matrix test device (RapidSwab) collected more total ng of DNA with both swabs compared to sequential and subsampling methods using the Puritan swabs. Only the sequential method results were statistically significant. The proportion of total ng DNA varied across swabs: the RapidSwab consisted of 70% cotton and 30% flocked, Puritan sequential contained 98% cotton and 2% flocked, and Puritan subsampling was 99.7% cotton and 0.3% flocked.

Results for samples collected from saliva stained cotton fabric surfaces are shown in FIG. 11A-B. Results of FIG. 11A indicate that all cotton swab samples provided ample amounts of DNA. For the flocked swabs, the inventive dual matrix test device (RapidSwab) flocked swab provided 3.5× (p<0.05) more DNA than the Puritan flocked swab using sequential collection and >20× (p not determined) more DNA than the Puritan flocked swab using subsampling collection, which resulted in seven samples with DNA quantities <0.001 ng/μL and three samples where no DNA was detected. DNA quantity values of <0.001 ng/μL were reported as 0.001 ng/μl and statistical calculations were not performed.

The DI values for all samples were between 1.2 and 1.5, indicating little or partial DNA degratation. The most DNA degradation likely occurred in the Puritan flocked swab using sequential collection.

Results of FIG. 11B indicate that the inventive dual matrix test device (RapidSwab) collected similar total ng of DNA compared to Puritan swabs with sequential sampling and more total ng of DNA compared to Puritan swabs with subsampling (p>0.05), although the difference was not statistically significant. The proportion of total ng DNA varied across swabs: the RapidSwab consisted of 76% cotton and 24% flocked, Puritan sequential contained 93% cotton and 7% flocked, and Puritan subsampling was 95% cotton and 5% flocked.

These results provide proof of concept that the inventive dual matrix test device (RapidSwab) is an improved design for DNA crime scene collection because its dual swabs consistently and proportionately collect DNA from different biological fluid-stained surfaces onto both flocked and cotton swabs, thereby supporting both Rapid DNA and traditional lab testing. The design of the inventive dual matrix test device (RapidSwab) provides improved handling with dual shaft stability during sampling, allowing for simultaneous sample collection while applying approximately the same contact force between each swab and the surface. Specimen collector stability and housing container design allow for protected storage and desiccation of collected samples in the housing container without accidental transfer of collected samples to the container sides.

Having fully described the invention and exemplary embodiments, the invention is further defined by the claims which follow.

1. A specimen collection device 1 comprising a specimen collector assembly 2 comprising at least two specimen collectors 3 extending from a central member 4, the specimen collectors 3 comprising:
(a) a first swab 5a comprising a first collection matrix 6a connected to a first shaft 7a, the shaft having a first shaft end with the first collection matrix 6a thereon and a second shaft end connected to the central member 4;
(b) a second swab 5b comprising a second collection matrix 6b connected to a second shaft 7b, the shaft having a first shaft end with the second collection matrix 6b thereon and a second shaft end connected to the central member 4;
wherein the first and second swabs 5a and 5b are configured to simultaneously contact one or more specimens to collect one or more samples on the swabs, the first swab 5a being positioned to not contact the second swab 5b.

2. The device of claim 1, wherein:
(a) the first collection matrix 6a and the second collection matrix 6b are each independently selected from Group (I) consisting of a flocked matrix, a fibrous matrix, a foam matrix, a spun matrix, a knitted matrix, a mesh matrix, a cotton matrix, a cellulose matrix, a calcium alginate matrix, a microfiber matrix, a polymeric matrix, a polyester matrix, a nylon matrix, a rayon matrix, a polyethylene matrix, a polyethylene terephthalate matrix, a matrix comprising dissolvable polymers, a matrix comprising bicomponent fibers, a polypropylene matrix, a polyurethane matrix, a polyacrylonitrile matrix, and a polylactic acid matrix; and
(b) the first collection matrix 6a and the second collection matrix 6b are different matrices.

3. The device of claim 2, wherein:
(a) the first collection matrix 6a comprises said flocked matrix; and the second collection matrix 6b comprises a non-flocked matrix selected from said Group (I);
(b) the first collection matrix 6a comprises said flocked matrix; and the second collection matrix 6b comprises said fibrous matrix, said foam matrix, said spun matrix, said knitted matrix, or said mesh matrix;
(c) the first collection matrix 6a comprises said flocked matrix comprising one or more fibers selected from the group consisting of microfibers, polymeric fibers, polyester fibers, nylon fibers, rayon fibers, polyethylene fibers, polyethylene terephthalate fibers, dissolvable polymeric fibers, bicomponent fibers, polypropylene fibers, polyurethane fibers, polyacrylonitrile fibers, and polylactic acid fibers; and
the second collection matrix 6b comprises said fibrous matrix, said foam matrix, said spun matrix, said knitted matrix, or said mesh matrix comprising one or more fibers selected from the group consisting of cotton fibers, cellulose fibers, calcium alginate fibers, microfibers, polymeric fibers, polyester fibers, nylon fibers, rayon fibers, polyethylene fibers, polyethylene terephthalate fibers, dissolvable polymeric fibers, bicomponent fibers, polypropylene fibers, polyurethane fibers, polyacrylonitrile fibers, and polylactic acid fibers;
(d) the first collection matrix 6a comprises said flocked matrix comprising polyester fibers and/or nylon fibers; and the second collection matrix 6b comprises said fibrous matrix, said spun matrix, said knitted matrix, or said mesh matrix comprising cotton fibers; or
(e) the first collection matrix 6a comprises said flocked matrix comprising polyester fibers and/or nylon fibers; and the second collection matrix 6b comprises said spun matrix comprising cotton fibers.

4. The device of claim 3, wherein:
(a) the first collection matrix 6a and the second collection matrix 6b are compatible with a laboratory DNA test, a laboratory chemical test, any laboratory test, a rapid DNA test, a rapid chemical test, and/or any rapid field test;
(b) the first collection matrix 6a is compatible with at least said rapid DNA test, said rapid chemical test, or any rapid field test; and the second collection matrix 6b is compatible with at least said laboratory DNA test, said laboratory chemical test, or any laboratory test; or
(c) the first collection matrix 6a is compatible with at least said rapid DNA test, said rapid chemical test, or any rapid field test that uses smaller amounts of liquid than previous iterations of said rapid test; and the second collection matrix 6b is compatible with at least said laboratory DNA test, said laboratory chemical test, or any laboratory test.

5. The device of claim 1, wherein said one or more samples on the swabs comprise (i) two samples of the same specimen, (ii) a sample of the specimen and a sample of an adjacent specimen, (iii) a sample of the specimen and a control sample, or (iv) two control samples.

6. The device of claim 1, wherein said central member 4 forms part of a container closure 9 having a first side 9a and a second side 9b, which are opposed sides of said central member 4, and wherein:
(a) the specimen collectors 3 extend from the first side 9a of the container closure 9; and
(b) the second shaft ends of the first and second swabs 5a and 5b are connected to the first side 9a of the container closure 9.

7. The device of claim 6, wherein said container closure 9 further comprises:
(a) a first stopper structure 10a extending from the first side 9a of the central member 4;
(b) a second stopper structure 10b or a handle for the specimen collector assembly 2 extending from the second side 9b of the central member 4;
(c) a first void hole 11a and a second void hole 11b located on the first side 9a of the container closure 9 into which the second shaft ends of the first and second swabs 5a and 5b are positioned; and
(d) optionally at least one air hole 12 communicating through the stopper structures 10a and 10b and the central member 4 of the container closure 9.

8. The device of claim 1, wherein the specimen collector assembly 2 further comprises a first generally rigid tube 8a mounted coaxially on the first shaft 7a and a second generally rigid tube 8b mounted coaxially on the second shaft 7b, each generally rigid tube 8a and 8b having:
(a) a first end of each generally rigid tube 8a and 8b connected to the first side 9a of the container closure 9, the first end of each generally rigid tube 8a and 8b being optionally positioned inside the first and second void holes 11a and 11b of the container closure 9; and
(b) a second end optionally terminating at a shaft break point, which is optionally perforated, on each of said shafts 7a and 7b, said optional shaft break points being positioned along each of said shafts 7a and 7b at a location sufficiently spaced from each of said swabs 5a and 5b to permit the entire swab to be separated from the shaft when the shaft is broken at said shaft break point.

9. The device of claim 1, further comprising a housing container 13 for holding and/or transporting the specimen collector assembly 2, the housing container 13 comprising an opening 16, wherein the first side 9a of said container closure 9 is insertable into the opening 16, wherein the housing container 13:
(a) comprises any container of sufficient size and shape to permit insertion of the specimen collectors 3 without contacting the specimen collectors 3, the first and second swabs 5a and 5b, or the first and second collection matrices 6a and 6b; and
(b) is configured to isolate and contain at least the first and second swabs 5a and 5b without contacting the first and second swabs 5a and 5b or the first and second collection matrices 6a and 6b.

10. The device of claim 9, wherein the housing container 13:
(a) is configured to act both as a handle for the specimen collector assembly 2 during specimen collection and to act as a transport container during specimen shipping;
(b) comprises a desiccant chamber 14;
(c) comprises a neck 15 extending from the desiccant chamber 14 the neck 15 having said opening 16 providing communication through the neck 15 and into the desiccant chamber 14, wherein said first stopper structure 10a and/or said second stopper structure 10b are insertable into the opening 16 of the neck 15, which is tapered to form a seat 17 for one or both stopper structures 10a and 10b;
(d) comprises a swab isolation region 18 in the desiccant chamber 14 the swab isolation region 18 aligned with the neck 15 to permit insertion of the first and second swabs 5a and 5b through the opening 16, through the neck 15, and into the swab isolation region 18;
(e) comprises a desiccant holding region 19 on at least one sidewall of the desiccant chamber 14, the desiccant holding region 19 configured to retain at least one desiccant packet 20 therein to absorb moisture from a specimen collected on the first and second swabs 5a and 5b;
(f) comprises a base cap 21 on the desiccant chamber 14, wherein the base cap 21 is optionally openable and closeable and is optionally configured to permit removal of the desiccant packet 20 from the desiccant holding region 19 and insertion of the desiccant packet 20 into the desiccant holding region 19 while the first and second swabs 5a and 5b are in the swab isolation region 18 of the desiccant chamber 14; or
(g) any combination of (a)-(f).

11. The device of claim 10, further comprising one or more retaining structures 22 in the desiccant chamber 14 the retaining structures 22 being configured to hold the desiccant packet 20 in the desiccant holding region 19 and away from contact with the first and second swabs 5a and 5b, wherein the retaining structures 22:
(a) comprise rigid flanges extending from opposed sidewalls of the desiccant chamber 14;
(b) comprise flexible retainers extending downwardly from a top wall of the desiccant chamber 14;
(c) comprise flexible projections extending upwardly from the optionally openable and closeable base cap 21; or
(d) comprise flexible projections extending both downwardly from the top wall and inwardly from opposed sidewalls of the desiccant chamber 14.

12. The device of claim 1, wherein:
(a) the two specimen collectors 3 have approximately the same total lengths;
(b) the two specimen collectors 3 have approximately the same stiffnesses;
(c) a total length of the first shaft 7a and the first swab 5a extending from the central member 4 is approximately the same as a total length of the second shaft 7b and the second swab 5b extending from the central member 4;
(d) a stiffness of the first swab 5a comprising the first collection matrix 6a connected to the first shaft 7a is approximately the same as a stiffness of the second swab 5b comprising the second collection matrix 6b connected to the second shaft 7b;
(e) a stiffness of the first shaft 7a is approximately the same as a stiffness of the second shaft 7b;
(f) a combined stiffness of the first shaft 7a and the first swab 5a is approximately the same as a combined stiffness of the second shaft 7b and the second swab 5b;
(g) a diameter of the first shaft 7a is approximately the same as a diameter of the second shaft 7b;
(h) each generally rigid tube 8a and 8b has approximately the same length;
(i) each generally rigid tube 8a and 8b has approximately the same stiffness;
(j) each generally rigid tube 8a and 8b has a stiffness that is greater than the stiffness of the first shaft 7a and the second shaft 7b; or
(k) any combination of (a)-(j).

13. A method of specimen collection comprising the steps of:
(a) applying one or both swabs of a specimen collection device 1 comprising a specimen collector assembly 2 comprising at least two specimen collectors 3 according to any of claims 1-12 to at least one specimen,
wherein the two specimen collectors 3 comprise a first swab 5a comprising a first collection matrix 6a connected to a first shaft 7a, the shaft having a first shaft end with the first collection matrix 6a thereon and a second shaft end connected to the central member 4; and a second swab 5b comprising a second collection matrix 6b connected to a second shaft 7b, the shaft having a first shaft end with the second collection matrix 6b thereon and a second shaft end connected to the central member 4,
wherein the first and second swabs 5a and 5b are configured to simultaneously contact one or more specimens to collect one or more samples on the swabs, the first swab 5a being positioned to not contact the second swab 5b; and
(b) collecting a sample of the at least one specimen onto one or both swabs, thereby providing a first sample on the first collection matrix 6a and/or a second sample on the second collection matrix 6b.

14. The method of claim 13, wherein the first swab and the second swab are simultaneously or subsequently applied to:
(a) two adjacent areas on the same specimen;
(b) a same area on the same specimen;
(c) areas on two adjacent specimens;
(d) a specimen and an adjacent control area; or
(e) two adjacent control areas.

15. The device of claim 13, wherein said one or more samples on the swabs comprise (i) two samples of the same specimen, (ii) a sample of the specimen and a sample of an adjacent specimen, (iii) a sample of the specimen and a control sample, or (iv) two control samples.

16. The method of and one of claim 13, further comprising the steps of:
(a) analyzing the first sample on the first collection matrix 6a for data regarding the specimen or the control; and/or
(b) analyzing the second sample on the second collection matrix 6b for data regarding the specimen or the control.

17. The method of any one of claim 13, further comprising the steps of:
(a) analyzing the first sample on the first collection matrix 6a and/or the second sample on the second collection matrix 6b using a laboratory DNA test, a laboratory chemical test, any laboratory test, a rapid DNA test, a rapid chemical test, and/or a rapid field test for data regarding the specimen or the control, optionally wherein the rapid DNA test, the rapid DNA test, and/or the rapid field test uses smaller amounts of liquid than previous iterations of said rapid test;
(b) analyzing the first sample on the first collection matrix 6a using said rapid DNA test, said rapid chemical test, or said rapid field test for data regarding the specimen or the control, wherein the rapid DNA test, the rapid DNA test, and/or the rapid field test uses smaller amounts of liquid than previous iterations of said rapid test;
(c) analyzing the second sample on the second collection matrix 6b using a laboratory DNA test, a laboratory chemical test, or a laboratory test for data regarding the specimen to provide specimen data; or
(d) a combination of (b) and (c).

18. The method of any one of claim 13, further comprising the steps of:
(a) pre-wetting the one or more specimens with sterile water, water, a liquid, or a solution optionally comprising one or more surfactants prior to applying the swabs to the specimen;
(b) pre-wetting one or both of said first and second swabs 5a and 5b and/or one or both of said first and second collection matrices 6a and 6b with sterile water, water, a liquid, or a solution optionally comprising one or more surfactants prior to applying the swabs to the specimen;
(c) after collecting the sample of the specimen, inserting both swabs 5a and 5b into the neck 15 of the housing container 13 to place the swabs in the swab isolation region 18 of the desiccant chamber 14;
(d) after inserting both swabs 5a and 5b into the neck 15 of the housing container 13, aligning the first swab 5a or second swab 5b with an indicator located on the neck 15 of the housing container 13, wherein both swabs are positioned within the swab isolation region 18 in a position that provides uniform separation between each of the swabs and the desiccant packets 20;
(e) inserting one or more desiccant packets 20 into the desiccant holding region 19, wherein the one or more desiccant packets 20 are held in place and away from contact with the first and second swabs 5a and 5b by said retaining structures 22;
(f) drying both swabs within the desiccant chamber 14;
(g) during the step of drying both swabs, optionally replacing one or more of said desiccant packets 20 in the desiccant holding region 19;
(h) transporting the swabs to a second location; or
(i) any combination of (a)-(h).

19. The method of any one of claim 13, wherein:
(a) the first and second collection matrices 6a and 6b are applied to the specimen surface with approximately the same contact force between each collection matrix and the specimen surface;
(b) the first and second swabs 5a and 5b are applied to the specimen surface with approximately the same contact force between each swab and the specimen surface;
(c) a total length of the first shaft 7a and the first swab 5a extending from the central member 4 is approximately the same as a total length of the second shaft 7b and the second swab 5b extending from the central member 4;
(d) a stiffness of the first swab 5a comprising the first collection matrix 6a connected to the first shaft 7a is approximately the same as a stiffness of the second swab 5b comprising the second collection matrix 6b connected to the second shaft 7b;
(e) a stiffness of the first shaft 7a is approximately the same as a stiffness of the second shaft 7b;
(f) a combined stiffness of the first shaft 7a and the first swab 5a is approximately the same as a combined stiffness of the second shaft 7b and the second swab 5b;
(g) a diameter of the first shaft 7a is approximately the same as a diameter of the second shaft 7b;
(h) the two specimen collectors 3 have approximately the same total lengths;
(i) the two specimen collectors 3 have approximately the same stiffnesses; or
(j) any combination of (a)-(i).
